(19) United States
(12) Patent Application Publication
(10) Pub. No.: US 2023/0224959 A1
(43) Pub. Date: Jul. 13, 2023

(54) CHANNEL ACCESS WITH RESERVATION FOR SIDELINK COMMUNICATION IN UNLICENSED SPECTRUM

(71) Applicant: QUALCOMM Incorporated, San Diego, CA (US)

(72) Inventors: Shuanshuan WU, San Diego, CA (US); Shailesh PATIL, San Diego, CA (US); Arthur GUBESKYS, San Diego, CA (US); Gene Wesley MARSH, San Diego, CA (US); Stelios STEFANATOS, San Diego, CA (US)

(21) Appl. No.: 17/997,653

(22) PCT Filed: May 28, 2021
(86) PCT No.: PCT/US2021/034819

§ 371 Date: Oct. 31, 2022

(30) Foreign Application Priority Data
Jun. 24, 2020 (GR) 20200100359

(51) Int. Cl. H04W 74/08; H04W 72/25; H04W 72/0446; H04W 72/54

(52) U.S. Cl. CPC H04W 74/0808; H04W 72/25; H04W 72/0446; H04W 72/54; H04W 16/14

(57) ABSTRACT

Methods, systems, and devices for wireless communications are described in which a user equipment (UE) may reserve one or more time frequency resources in an unlicensed frequency spectrum band for one or more sidelink transmissions. The UE may reserve the time frequency resources through a sidelink message transmitted in a first slot of a shared channel occupancy (CO). The UE may monitor a subset of slots before the reserved time frequency resources for sidelink transmissions from other UEs sharing the CO. The monitoring of the subset of slots may include decoding control messages or control information in each of the subset of slots, a reference signal received power (RSRP) measurement of sidelink transmissions in the subset of slots, channel sensing with energy detection in a sensing window, or a combination thereof. The UE may communicate in the reserved slot based on the monitoring.

### CROSS REFERENCES

The present application is a 371 national stage filing of International PCT Application No. PCT/US2021/034819 by WU et al., entitled “CHANNEL ACCESS WITH RESERVATION FOR SIDELINK COMMUNICATION IN UNLICENSED SPECTRUM,” filed May 28, 2021; and claims priority to Greek Patent Application No. 20200100359 by WU et al., entitled “CHANNEL ACCESS WITH RESERVATION FOR SIDELINK COMMUNICATION IN UNLICENSED SPECTRUM,” filed Jun. 24, 2020, each of which is assigned to the assignee hereof, and each of which is expressly incorporated by reference in its entirety herein.

### FIELD OF TECHNOLOGY

The following relates generally to wireless communications and more specifically to channel access with reservation for sidelink communication in unlicensed spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support sidelink access communications, such as communications between multiple UEs (e.g., in a vehicle-to-everything (V2X) system, a vehicle-to-vehicle (V2V) system, a device-to-device (D2D) system, among other examples). Sidelink communications may be deployed in licensed frequency spectrum, or dedicated spectrum for intelligent transportation systems (ITS). Sidelink communications may also be deployed in unlicensed or shared radio frequency spectrum band, which may be shared with other technologies and users. However, sidelink communications in unlicensed spectrum may introduce challenges to channel access due to sharing the frequency spectrum with other technologies (e.g., Wi-Fi) as well as other channel sensing regulations of the spectrum.

### SUMMARY

The described techniques relate to improved methods, systems, devices, and apparatuses that support channel access with reservation for sidelink communication in unlicensed spectrum. Generally, the described techniques provide for efficient channel access for sidelink communications in unlicensed spectrum. A user equipment (UE) may gain access to a sidelink channel of an unlicensed or shared spectrum for an interval of time, which may be referred to as a channel occupancy time (COT) or channel occupancy (CO). The UE may transmit or receive sidelink messages over the sidelink channel during the COT. A wireless communications system using unlicensed spectrum may implement sidelink COT sharing, which may enable multiple UEs to perform sidelink communications during the same COT.

In some cases, a UE may reserve one or more time frequency resources (e.g., symbols, slots, mini slots) within the shared COT for one or more sidelink transmissions. In some examples, the UE may reserve the time frequency resources through a sidelink message transmitted in a slot (e.g., a reserving sidelink transmission). The message may include resource reservation information, which may be included in sidelink control information (SCI) corresponding to the sidelink message. The UE may monitor a subset of time-frequency resources before a reserved resource for sidelink transmissions from other UEs sharing the COT. If the UE monitors continuous sidelink transmission or discontinuous sidelink transmission with each gap value less than a threshold (e.g., 16 μs or 25 μs) over the subset of time-frequency resources, the UE may transmit a sidelink transmission in the reserved resource. If the UE monitors discontinuous sidelink transmission(s) with at least one gap value greater than a threshold (e.g., 16 μs or 25 μs), the UE may assume that the reserved resource may be no longer accessible, and in some cases, the UE may give up transmission in the reserved resource. Additionally or alternatively, the UE may perform channel sensing (e.g., Category 2 listen-before-talk (LBT)) prior to using the reserved resource. For example, the UE may transmit the sidelink transmission in the reserved resource if the UE determines that the channel is accessible after performing channel sensing (e.g., the measured energy level is below an energy threshold in a sensing duration).

In some examples, the UE may reserve time frequency resources in a slot consecutive to the reserving sidelink transmission slot of the UE. The UE may transmit a sidelink transmission in the consecutive reserved slot without performing channel sensing (e.g., Category 2 LBT or Category 4 LBT). In some cases, the UE may reserve the consecutive slot if the reserving sidelink transmission does not request hybrid automatic repeat request (HARQ) feedback.

A method of wireless communications at a UE is described. The method may include determining that a CO in a shared radio frequency spectrum band is available for use by the UE for sidelink transmission, transmitting a message in a first slot of the CO using a channel of the shared radio frequency spectrum band, the message indicating a reserved slot within the CO for a subsequent communication by the UE, and communicating in the reserved slot based on one or more control messages between the first slot and the reserved slot, one or more reference signal received power (RSRP) measurements between the first slot and the reserved slot, a channel sensing procedure with energy detection within a sensing window, or a combination thereof.

An apparatus for wireless communications at a UE is described. The apparatus may include a processor, memory coupled with the processor, and instructions stored in the memory. The instructions may be executable by the processor to cause the apparatus to determine that a CO in a shared radio frequency spectrum band is available for use by the UE for sidelink transmission, transmit a message in a first slot of the CO using a channel of the shared radio frequency spectrum band, the message indicating a reserved slot within the CO for a subsequent communication by the UE, and communicate in the reserved slot based on one or more control messages between the first slot and the reserved slot, one or more RSRP measurements between the first slot and the reserved slot, a channel sensing procedure with energy detection within a sensing window, or a combination thereof.

Another apparatus for wireless communications at a UE is described. The apparatus may include means for determining that a CO in a shared radio frequency spectrum band is available for use by the UE for sidelink transmission, transmitting a message in a first slot of the CO using a channel of the shared radio frequency spectrum band, the message indicating a reserved slot within the CO for a subsequent communication by the UE, and communicating in the reserved slot based on one or more control messages between the first slot and the reserved slot, one or more RSRP measurements between the first slot and the reserved slot, a channel sensing procedure with energy detection within a sensing window, or a combination thereof.

A non-transitory computer-readable medium storing code for wireless communications at a UE is described. The code may include instructions executable by a processor to determine that a CO in a shared radio frequency spectrum band is available for use by the UE for sidelink transmission, transmit a message in a first slot of the CO using a channel of the shared radio frequency spectrum band, the message indicating a reserved slot within the CO for a subsequent communication by the UE, and communicate in the reserved slot based on one or more control messages between the first slot and the reserved slot, one or more RSRP measurements between the first slot and the reserved slot, a channel sensing procedure with energy detection within a sensing window, or a combination thereof.

Some examples of the method, apparatuses, and non-transitory computer-readable medium described herein may further include operations, features, means, or instructions for detecting one or more sidelink control messages from at least one other UE indicating a set of reserved slots reserved by the at least one other UE for subsequent communications within the CO, and selecting the reserved slot based on the set of reserved slots such that each slot between the first slot and the reserved slot may be reserved by the UE or the at least one other UE.

Some examples of the method, apparatuses, and non-transitory computer-readable medium described herein may further include operations, features, means, or instructions for selecting the reserved slot to be consecutive to the first slot, and refraining from performing the channel sensing procedure before the reserved slot based on the reserved slot and the first slot being consecutive.

Some examples of the method, apparatuses, and non-transitory computer-readable medium described herein may further include operations, features, means, or instructions for selecting the reserved slot to be consecutive to the first slot based on transmissions in the first slot by the UE being independent of feedback in response to the transmissions.

In some examples of the method, apparatuses, and non-transitory computer-readable medium described herein, communicating the reserved slot may include operations, features, means, or instructions for transmitting a feedback request for transmissions in the reserved slot.

In some examples of the method, apparatuses, and non-transitory computer-readable medium described herein, the feedback request specifies one or more slots within the CO reserved for feedback.

Some examples of the method, apparatuses, and non-transitory computer-readable medium described herein may further include operations, features, means, or instructions for detecting, as part of the channel sensing procedure, one or more sidelink control messages from at least one other UE in a second slot preceding the reserved slot, where the second slot and the reserved slot may be consecutive, and communicating in the reserved slot based on detecting the one or more sidelink control messages.

Some examples of the method, apparatuses, and non-transitory computer-readable medium described herein may further include operations, features, means, or instructions for detecting, as part of the channel sensing procedure, one or more sidelink control messages from at least one other UE in each slot between the first slot and the reserved slot, and communicating in the reserved slot based on detecting the one or more sidelink control messages in each slot between the first slot and the reserved slot.

Some examples of the method, apparatuses, and non-transitory computer-readable medium described herein may further include operations, features, means, or instructions for communicating in the reserved slot based on an RSRP measurement of sidelink transmissions in all slots between the first slot and the reserved slot exceeding an RSRP threshold.

Some examples of the method, apparatuses, and non-transitory computer-readable medium described herein may further include operations, features, means, or instructions for communicating in the reserved slot based on an RSRP measurement of sidelink transmissions in a second slot consecutive to the reserved slot exceeding an RSRP threshold.

Some examples of the method, apparatuses, and non-transitory computer-readable medium described herein may further include operations, features, means, or instructions for communicating in the reserved slot based on the energy detection in the sensing window between the first slot and the reserved slot being below an energy detection threshold.

Some examples of the method, apparatuses, and non-transitory computer-readable medium described herein may further include operations, features, means, or instructions for performing energy detection in one or more symbols of a second slot preceding the reserved slot, where the second slot and the reserved slot may be consecutive.

Some examples of the method, apparatuses, and non-transitory computer-readable medium described herein may further include operations, features, means, or instructions for determining the one or more symbols based on a sensing window size, a reception mode to transmission mode transition time, a fixed gap value, or a combination thereof.

Some examples of the method, apparatuses, and non-transitory computer-readable medium described herein may further include operations, features, means, or instructions for transmitting a feedback request for transmissions in the first slot, the feedback request indicating that the reserved slot may be for feedback for the transmissions.

Some examples of the method, apparatuses, and non-transitory computer-readable medium described herein may further include operations, features, means, or instructions for transmitting a feedback request for transmissions in the first slot, the feedback request indicating that the reserved slot and one or more other slots within the CO may be for feedback for the transmissions.

Some examples of the method, apparatuses, and non-transitory computer-readable medium described herein may further include operations, features, means, or instructions for receiving, in the reserved slot, feedback for the transmissions in the first slot, and releasing the one or more other slots based on receiving feedback for the transmissions in the first slot.

### BRIEF DESCRIPTION OF THE DRAWINGS

FIG. 1 illustrates an example of a wireless communications system that supports channel access with reservation for sidelink communication in unlicensed spectrum in accordance with aspects of the present disclosure.

FIG. 2 illustrates an example of a wireless communications system that supports channel access with reservation for sidelink communication in unlicensed spectrum in accordance with aspects of the present disclosure.

FIG. 3 illustrates an example of a time-frequency diagram that supports channel access with reservation for sidelink communication in unlicensed spectrum in accordance with aspects of the present disclosure.

FIG. 4 illustrates an example of a time-frequency diagram that supports channel access with reservation for sidelink communication in unlicensed spectrum in accordance with aspects of the present disclosure.

FIG. 5 illustrates an example of a time-frequency diagram that supports channel access with reservation for sidelink communication in unlicensed spectrum in accordance with aspects of the present disclosure.

FIG. 6 illustrates an example of a process flow diagram that supports channel access with reservation for sidelink communication in unlicensed spectrum in accordance with aspects of the present disclosure.

FIGS. 7 and 8 show block diagrams of devices that support channel access with reservation for sidelink communication in unlicensed spectrum in accordance with aspects of the present disclosure.

FIG. 9 shows a block diagram of a communications manager that supports channel access with reservation for sidelink communication in unlicensed spectrum in accordance with aspects of the present disclosure.

FIG. 10 shows a diagram of a system including a device that supports channel access with reservation for sidelink communication in unlicensed spectrum in accordance with aspects of the present disclosure.

FIGS. 11 through 14 show flowcharts illustrating methods that support channel access with reservation for sidelink communication in unlicensed spectrum in accordance with aspects of the present disclosure.

### DETAILED DESCRIPTION

A wireless communications system may support sidelink communications between wireless devices, such as a user equipment (UE) or other sidelink devices, and such sidelink techniques may support one or more of device-to-device (D2D) communications, vehicle-to-everything (V2X), or vehicle-to-vehicle (V2V) communications, message relaying, discovery signaling, beacon signaling, or other signals transmitted over-the-air from one wireless device to at least one other wireless device. In some cases, sidelink communications may support unicast messaging, groupcast messaging, multicast messaging, broadcast messaging, or combinations thereof. Sidelink communications may deploy in licensed frequency spectrum (e.g., licensed cellular spectrum, intelligent transportation systems (ITS) dedicated spectrum) or in unlicensed (e.g., shared) frequency spectrum.

In some examples, sidelink communications may support resource (e.g., symbol, slot, mini slot) reservation in autonomous resource allocation for licensed radio frequency spectrum. For example, a UE may identify future time frequency resources (e.g., candidate resources) of a channel available for future sidelink transmission within a selection window. In some cases, to identify candidate resources, the UE may identify time frequency resources reserved by other UEs that communicate using the channel. The UE may monitor each sidelink transmission of the channel within a sensing window, which may include one or more time frequency resources, prior to a reserving sidelink transmission for the UE. In some cases, the UE may monitor the sidelink transmissions within the sensing window by decoding sidelink control information (SCI) for each sidelink transmission within the sensing window. The SCI may provide resource reservation information of time frequency resources reserved for a sidelink transmission by the corresponding UE transmitting the sidelink transmission. In some cases, the UE may identify reserved resources by performing a reference signal received power (RSRP) measurement for each sidelink transmission decoded within the sensing window. The UE may project the RSRP measurement to corresponding reserved resources in the SCI, and compare the RSRP measurement to an RSRP metric (e.g., threshold value) to identify the corresponding resources as reserved (e.g., busy). If the RSRP measurement is above the RSRP threshold for a given transmission, the UE may determine that the corresponding reserved resources are busy. If the RSRP measurement is below the RSRP threshold for a given transmission, the UE may determine that the corresponding reserved resources are available as candidate resources. The UE may then select one or more resources from the candidate resources in the selection window, the candidate resources including one or more resources which may be identified as available in the selection window. The UE may select the one or more resources from the candidate resources upon a triggering for resource selection or an arrival of a packet for transmission. In some cases, the UE may identify the candidate resources in the selection window based on the SCI decoding, the RSRP measurement, or a combination thereof and may then select to reserve candidate resources. In some examples, the UE may select a resource for its current transmission, and the UE may also select a number of resources for future use. In some cases. the UE may reserve the selected resources by indicating reservations via sidelink control signaling in a sidelink transmission performed by the UE. In some examples, the UE may schedule its reserved resources in future slots to transmit a retransmission of information (e.g., packet) from a sidelink transmission.

In some examples, sidelink communications may support resource reservation in unlicensed radio frequency spectrum, which may introduce challenges to channel access. For instance, if a set of wireless devices share a channel occupancy time (COT) (also referred to channel occupancy (CO)) of an unlicensed channel, access to the unlicensed channel during the COT may be lost if transmissions such as V2X transmissions are discontinuous such that one or more gaps between subsequent transmissions exceed a gap threshold (e.g., 16 μs or 25 μs). As such, a wireless device may not be guaranteed that a resource reserved by the wireless device will be available within a COT of an unlicensed channel. Additionally or alternatively, some wireless devices utilizing the shared channel may operate according to a different radio access technology (e.g., Wi-Fi) and may be unable to properly decode sidelink transmission such as V2X sidelink transmissions which may result in the wireless devices not identifying the reserved resources. Further, channel sensing regulations (e.g., listen-before-talk (LBT), COT) may include additional procedures for the UE to reserve time frequency resources and transmit sidelink transmission using the reserved time frequency resources in unlicensed spectrum, which may limit the ability of a UE to access and utilize the reserved resources of the unlicensed channel.

In some cases using channel sensing (e.g., LBT), a wireless device may sense energy and may send a transmission if the energy is below a threshold. In some examples, a wireless device may use Category 1 LBT, which includes using LBT without energy sensing (e.g., the device may transmit immediately, similar to Type 2c channel access in NR unlicensed (NR-U)). In some cases, the wireless device may use Category 2 LBT, which includes using LBT without random back-off (e.g., the device may transmit if the device senses energy in some period below a threshold, similar to Type 2a and Type 2b channel access in NR-U). In some examples, the wireless device may use Category 4 LBT, which includes using LBT with random back-off with a contention window of variable size (e.g., the device may transmit if the device senses energy in a contention window below a threshold, similar to Type 1 channel access in NR-U).

Techniques are described herein for channel access for sidelink communications in unlicensed spectrum. A UE may gain access to a sidelink channel and initiate a CO having a given COT. The UE may transmit one or more sidelink transmissions over the sidelink channel during the COT. A wireless communications system in unlicensed radio frequency spectrum may implement sidelink COT sharing, which may enable multiple UEs to transmit one or more sidelink transmissions over the sidelink channel during a COT. In some cases, a wireless node (base station, core network node, road side unit (RSU), etc.) may initiate and enable COT sharing for sidelink transmissions. In some cases, the COT may be limited to a given time interval (e.g., 2 ms, 5 ms, 10 ms).

In some implementations, the UE may reserve one or more time frequency resources (e.g., one or multiple resource blocks (RBs) or subchannels in one or multiple slots) within the shared COT for one or more sidelink transmissions. The UE may reserve resources in slots which may be consecutive, non-consecutive, or both. In some cases, the UE may reserve time frequency resources through a message transmitted in a slot (e.g., a reserving sidelink transmission). The message may include resource reservation information, which may be included in SCI corresponding to the message. In some examples, other UEs (a second UE, a third UE, etc.) sharing the COT may decode the message. After decoding the message, the other UEs may designate the reserved resources indicated by the UE as busy, and may exclude those resources from being candidate resources of their own reservations.

In some cases, the UE may monitor a subset of slots before a reserved resource for sidelink transmissions from other UEs sharing the COT. In some cases, the UE may monitor for sidelink transmission in the subset of slots by decoding each sidelink transmission in the subset. In some examples, the subset of slots may be selected from a set of unreserved slots between each sidelink transmission of the UE within the COT. For instance, a first UE, sharing a COT with a second UE, may monitor a subset of slots (e.g., each slot between the first UE's reserving sidelink message transmission slot and the first UE's first future reserved slot) for sidelink transmission from the second UE. Alternatively, the subset of slots may be the preceding slot of a reserved resource. In some examples, if the UE monitors continuous sidelink transmission (e.g., each slot in the subset slots has sidelink transmission from other UE(s) been decoded) or discontinuous sidelink transmission with each gap value less than a threshold (e.g., 16 μs or 25 μs) in the subset of slots, the UE may determine that the reserved resource is accessible and communicate in the reserved resource. In some cases, if the UE monitors one or more sidelink transmissions in each slot in the subset of slots, the UE may utilize the reserved resource without performing channel sensing (e.g., Category 2 or Category 4 LBT).

In some cases, the UE may perform a channel sensing procedure preceding the transmission of the reserved resource (e.g., Category 2 LBT). For example, the UE may perform energy detection in a sensing window preceding the reserved resource. The UE may then transmit in the reserved resource if an energy detection level measured in the sensing window is below an energy detection threshold.

In some examples, if the UE monitors discontinuous sidelink transmission with any gap value greater than a threshold (e.g., 16 μs or 25 μs), the UE may perform channel sensing (e.g., LBT). In some cases, the channel sensing may include LBT Category 2 procedures (e.g., without back off, such as Type 2 channel access as defined in a standard such as the 3GPP standard), or LBT Category 4 procedures (e.g., with back off, such as Type 1 channel access as defined in a standard such as the 3GPP standard). The UE may transmit the sidelink transmission in the reserved resource if the UE confirms the channel is free for transmission in the resource after performing channel sensing (e.g., LBT). In some cases, the UE may use Category 1 LBT (e.g., LBT without energy sensing), Category 2 LBT (e.g., LBT without random back-off), or Category 4 LBT (e.g., LBT with random back-off with a contention window of variable size).

In some examples, if the UE monitors discontinuous sidelink transmission having a gap value greater than a threshold (e.g., 16 μs or 25 μs), the UE may give up or refrain from using or transmitting in the reserved resource. For example, the UE may assume the channel may be no longer accessible if the UE detects sidelink transmission discontinuity during a gap that exceed the threshold. Alternatively, the UE may perform channel sensing (e.g., LBT with random back-off) if the UE intends to resume sidelink transmission in the reserved resource or in the future.

In some examples, the UE may reserve a future slot consecutive to the UE's reserving sidelink transmission slot. The UE may transmit a sidelink transmission in the consecutive future reserved slot without performing channel sensing (e.g., LBT). In some cases, the UE may reserve the consecutive future slot if the reserving sidelink transmission does not request feedback (e.g., hybrid automatic repeat request (HARQ) feedback). In some cases, a reserved resource may be released (e.g., unreserved) based on HARQ feedback to a previous sidelink transmission transmitted by the UE.

Aspects of the disclosure are initially described in the context of wireless communications systems. Aspects are then described with respect to time-frequency plots and a process flow. Aspects of the disclosure are further illustrated by and described with reference to apparatus diagrams, system diagrams, and flowcharts that relate to channel access with reservation for sidelink communication in unlicensed spectrum.

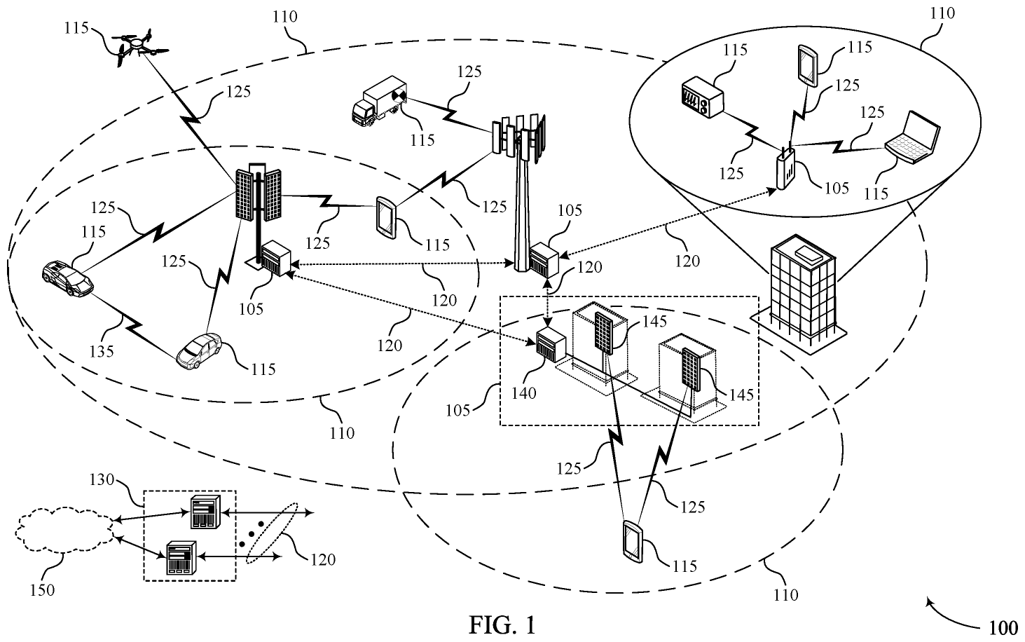

FIG. 1 illustrates an example of a wireless communications system 100 that supports channel access with reservation for sidelink communication in unlicensed spectrum in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples, (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a D2D communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, V2V communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 may gain access to a sidelink channel for a COT. In some cases, the COT may be configured as a given time interval (e.g., 2 ms, 5 ms, 10 ms). The UE 115 may transmit or receive one or more sidelink messages over the sidelink channel during the COT. For example, the UE 115 may transmit a message in a first slot of the COT using a channel of the shared radio frequency spectrum band. In some cases, the message may indicate future time frequency resources reserved within the COT. The UE 115 may monitor a subset of slots from a set of slots between each reserved time frequency resource within the COT. The UE 115 may communicate over the reserved time frequency resources without performing channel sensing (e.g., LBT) if the UE 115 monitors continuous sidelink transmission or discontinuous sidelink transmission with each gap of transmission less than a threshold (e.g., 16 μs or 25 μs) in the subset of slots. If the UE 115 monitors discontinuous sidelink transmission with any gap of transmission greater than a threshold (e.g., 16 μs or 25 μs) in the subset of slots, the UE 115 assumes the reserved resource may be no longer accessible and, in some cases, may drop the transmission via the reserved resource. Additionally or alternatively, the UE 115 may perform channel sensing (e.g., LBT) before determining whether the reserved resource is accessible by the UE 115.

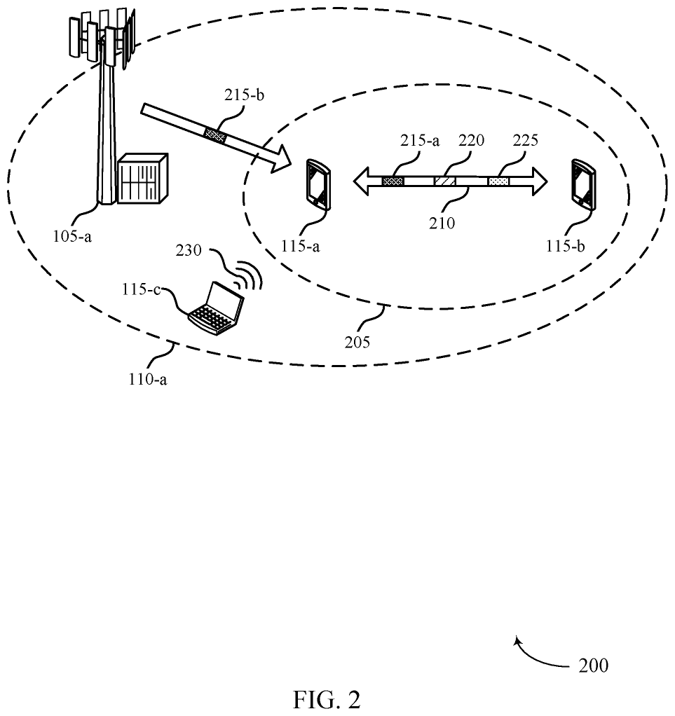

FIG. 2 illustrates an example of a wireless communications system 200 that supports channel access with reservation for sidelink communication in unlicensed spectrum in accordance with aspects of the present disclosure. In some examples, wireless communications system 200 may implement aspects of wireless communications system 100. Wireless communications system 200 may include base station 105-a, which may be an example of a base station 105 as described herein, and wireless device 115-a, wireless device 115-b, and wireless device 115-c, which may each be an example of a wireless device 115 described herein. While some examples of techniques for channel reservation for sidelink communications with COT sharing described herein are described as wireless device-to-wireless device COT sharing in a wireless device group 205, other devices may implement these techniques. For example, base stations 105, access points, relay nodes, or other types of wireless devices, may implement techniques similar to the wireless device group 205.

A wireless communications system 200 in unlicensed radio frequency spectrum may implement sidelink COT sharing, which may enable one or more wireless devices 115 to transmit one or more sidelink messages over a channel 210 during a COT. For example, a wireless device 115-a may determine that a channel 210 of a shared radio frequency spectrum band may be available for use for a COT. wireless device 115-a (or base station 105-a) may gain access to the channel 210 for the COT and may initiate COT sharing with a wireless device 115-b. In some cases, the channel 210 may be a physical shared channel (e.g., physical sidelink shared channel (PSSCH). wireless device 115-a may initiate COT sharing by transmitting a COT sharing configuration 215-a to wireless device 115-b. The COT sharing configuration 215-a may include SCI as well as sharing information for the COT. Based on the sharing information, wireless device 115-b may determine whether the COT supports sharing with wireless device 115-b. For instance, if wireless device 115-b determines that sharing is supported for the COT, wireless device 115-b may gain a capability time frequency resources in the channel 210 within the same COT as wireless device 115-a. In some examples, wireless device 115-b may transmit a sidelink feedback transmission to wireless device 115-a, or may transmit some combination thereof within the shared COT. In some examples, wireless device group 205 may include wireless device 115-a and wireless device 115-b sharing a COT. In some cases, wireless device group 205 may share the COT with wireless device 115-c.

In some cases, a wireless node (e.g., base station, RSU, etc.) may provide the sharing information to configure COT sharing for sidelink transmissions. For example, a base station 105-a may transmit COT sharing configuration 215-b to wireless device 115-a. The COT sharing configuration 215-b may include sharing information of a COT for one or more wireless devices 115 (e.g., wireless device group 205) over a geographic coverage area 110-a.

According to some aspects, wireless device group 205 may support resource reservation for sidelink communications in shared radio frequency spectrum over the shared COT. For example, wireless device 115-a may reserve one or more time frequency resources 225 (e.g., slots) within the shared COT for one or more sidelink transmissions in the channel. wireless device 115-a may reserve time frequency resources 225 which may be consecutive, non-consecutive, or both. In some cases, wireless device 115-a may reserve time frequency resources 225 through a reserving sidelink transmission 220. The reserving sidelink transmission 220 may include a message which may indicate resource reservation information. In some cases, the message may be included in SCI of the reserving sidelink transmission 220. In some examples, wireless device 115-b may detect the message. After detecting the message, wireless device 115-b may decode the message to designate reserved time frequency resources 225 indicated by wireless device 115-a as busy, and may exclude reserved time frequency resources 225 from being resources utilized in wireless device 115-b reservations.

Additionally or alternatively, wireless device 115-b may refrain from using the reserved time frequency resources 225 indicated by wireless device 115-a by performing an RSRP measurement on reserving sidelink transmission 220. In some cases, wireless device 115-b may project the RSRP measurement onto the reserved time frequency resources 225, and may compare the RSRP measurement to an RSRP metric (e.g., threshold value) to identify the time frequency resources 225 as reserved (e.g., busy). For instance, if wireless device 115-b measures an RSRP measurement over the reserving sidelink transmission 220 greater than an RSRP metric, wireless device 115-b may identify the time frequency resources 225 as reserved. In some cases, wireless device 115-a may implement similar processes of refraining from utilizing reserved resources of wireless device 115-b (e.g., SCI of the messages, RSRP measurement, or a combination thereof). In some examples, wireless device 115-a may identify reserved resources of wireless device 115-b by detecting and decoding messages transmitted in the channel 210 during or prior to COT sharing.

In some cases, while wireless device 115-a may reserve the time frequency resources 225, wireless device 115-a may not guarantee that reserved time frequency resources 225 may be available to access in the channel 210 when time to utilize reserved time frequency resources 225. While wireless device 115-b may identify those reserved time frequency resources 225 as busy, other wireless devices such as wireless device 115-c may not identify reserved time frequency resources 225 as busy and therefore may utilize reserved time frequency resources 225 due to wireless device 115-c operating in accordance with a different radio access technology (e.g., Wi-Fi). For example, wireless device 115-c may attempt to communicate over the channel 210 in the shared spectrum, and may transmit Wi-Fi signaling 230 if there may be any gap of transmission greater than a threshold (e.g., 16 μs or 25 μs) between reserving sidelink transmission 220 and reserved time frequency resources 225. As such, if there may be any gap of transmission greater than a threshold (e.g., 16 μs or 25 μs) between reserving sidelink transmission 220 and reserved time frequency resources 225, wireless devices 115 may lose access to the channel as a sidelink transmission transmitted by wireless device 115-a in reserved time frequency resources 225 may collide with transmissions from other technologies. For example, if wireless device 115-c accesses the channel during a gap, a transmission from wireless device 115-a in reserved time frequency resources 225 may collide with a transmission from wireless device 115-c in reserved time frequency resources 225.

To help mitigate transmission collisions, wireless device 115-a may monitor a subset of slots before reserved time frequency resources 225 for sidelink transmissions from other wireless devices (e.g., wireless device 115-b and wireless device 115-c) in the channel 210. In some examples, if wireless device 115-a monitors continuous sidelink transmission or discontinuous sidelink transmission with each gap of transmission less than a threshold (e.g., 16 μs or 25 μs) in the subset of slots, wireless device 115-a may transmit a sidelink transmission in reserved time frequency resource 225. For example, if wireless device 115-a detects continuous sidelink transmission or discontinuous sidelink transmission with each gap of transmission less than a threshold (e.g., 16 μs or 25 μs) in the subset of slots, the wireless device 115-a may determine that V2X wireless device may retain the COT and the wireless device 115-a may be able to transmit in the reserved time frequency resource 225. In some examples, if wireless device 115-a monitors discontinuous sidelink transmission with any gap of transmission greater than a threshold (e.g., 16 μs or 25 μs) in the subset of slots, wireless device 115-a may assume reserved time frequency resources 225 no longer accessible. In some examples, wireless device 115-a may give up transmission in reserved time frequency resources 225 and may perform channel sensing (e.g., Type 1 channel access procedure as specified in 3GPP, which may be referred to as Category 4 LBT (i.e., LBT with random back-off), or sidelink decoding based channel access as described previously) to access the channel 210 if wireless device 115-a still has a packet to transmit. In other examples, wireless device 115-a may perform channel sensing (e.g., Type 2 channel access procedure as specified in 3GPP, which may be referred to as Category 2 LBT (i.e., LBT without random back-off)) prior to utilizing the reserved time frequency resource 225. Wireless device 115-a may then utilize the time frequency resource 225 based on the channel availability after performing the channel sensing (e.g., Type 2 channel access).

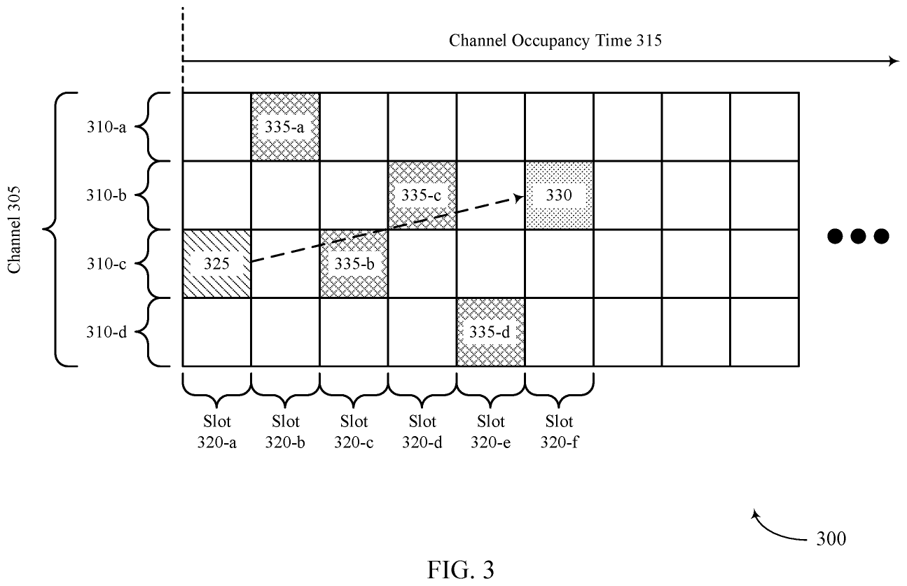

FIG. 3 illustrates an example of a time frequency diagram 300 that supports channel access with reservation for sidelink communication in unlicensed spectrum in accordance with aspects of the present disclosure. In some examples, time frequency diagram 300 may implement aspects of the wireless communications systems 100 or 200. In some examples, the time frequency diagram 300 may correspond to a COT 315 and may be a function of a frequency domain as well as a time domain. For example, time frequency diagram 300 may span a number of slots 320 (e.g., slot n, slot n+1, slot n+2, etc.) in a time domain of the COT 315, and may span a number of subchannels (e.g., subchannels 310-a through 310-d) of a channel 305 in the frequency domain. In some examples, resources of the time frequency diagram 300 may span one symbol by one subcarrier, or one symbol by multiple subcarriers.

The time frequency diagram 300 may include a first wireless device reserving a time frequency resource 330 in slot 320-f within a COT 315 shared with one or more other wireless devices (e.g., a second wireless device, a third wireless device, etc.). In some examples, the first wireless device may select a time frequency resource to reserve (e.g., time frequency resource 330). In some cases, selecting resources to reserve may include the first wireless device identifying resources 335 already reserved by either the first wireless device or other wireless devices. In some cases, the first wireless device may detect one or more sidelink transmissions transmitted from other wireless devices prior to the reserving slot 320-a. In some cases, the first wireless device may detect the one or more sidelink transmissions transmitted from other wireless devices in the prior slot to the reserving slot. Each sidelink transmission may include a sidelink control message or SCI which may indicate set of resources 335 reserved by the other wireless devices. For instance, the first wireless device may decode the sidelink control message or SCI of one or more sidelink transmissions transmitted prior to reserving slot and may designate the resources 335 reserved by the other wireless devices as reserved (e.g., busy). In some examples, the first wireless device may select to reserve a resource in the next unreserved slot (e.g., time frequency resource 330) of the COT subsequent to the reserving slot 320-a. In other examples, the first wireless device may select to reserve a resource in a random unreserved slot of the COT subsequent to the reserving slot 320-a. In other examples, the first wireless device may select to reserve a resource randomly from resources that are identified as available.

Additionally or alternatively, selecting resources to reserve may include the first wireless device identifying resources 335 already reserved by other wireless devices by performing an RSRP measurement on a control message or sidelink transmission(s) from the other wireless devices. The first wireless device may project the RSRP measurement onto the resources 335 indicated by the other wireless devices, and may compare the RSRP measurement to an RSRP metric (e.g., threshold value) to identify resources 335 as reserved (e.g., busy). For example, the first wireless device may measure an RSRP measurement for a sidelink transmission of a second wireless device. The sidelink transmission may be reserving the resources 335 for future sidelink transmission by the second wireless device. If the RSRP measurement is greater than an RSRP metric, the first wireless device may identify the resources 335 of the second wireless device as busy and may exclude it from candidate resources. If the RSRP measurement is less than the RSRP metric, the first wireless device may identify resources 335 as available and may identify resources 335 as candidate resources for the first wireless device.

In some cases, after selecting to reserve time frequency resource 330, the first wireless device may monitor a subset of slots before reserved time frequency resource 330 for sidelink transmissions from other wireless devices sharing the COT. The first wireless device may determine whether the reserved time frequency resource 330 may be accessible based on the monitoring of sidelink transmissions from the other wireless devices in each slot of the subset of slots. In some examples, the subset of slots may be selected from a set of slots between each sidelink transmission of the first wireless device within the COT. In some cases, the subset of slots may be each slot between the first wireless device's reserving sidelink message transmission slot and the first wireless device's future reserved slot. For example, the first wireless device may monitor a subset of slots which may include each slot between reserving resource 325 and reserved time frequency resource 330 for sidelink transmission from other wireless devices (e.g., slots 320-b, 320-c, 320-d, and 320-e). In some examples, the subset of slots may be the slot that preceding the slot having the reserved resource. For example, the first wireless device may monitor slot 320-e, the slot that is preceding the slot 320-f.

In some examples, the first wireless device may detect sidelink transmission from one or more other wireless devices the subset of slots (e.g., slots 320-b through 320-e) based on decoding control messages or SCI in each slot of the subset of slots. For instance, the first wireless device may detect sidelink transmission from a second wireless device in resource 335-a based on decoding the control message or SCI of sidelink transmission transmitted by the second wireless device. Additionally or alternatively, decoding the control message or SCI of other wireless devices may indicate future resources reserved by other wireless devices. For instance, a second wireless device in the shared COT may utilize resource 335-a to reserve resource 335-b. The first wireless device may decode the reserving sidelink transmission in resource 335-a, and may designate resource 335-b as reserved (e.g., busy).

In some examples, the first wireless device may detect sidelink transmission from one or more other wireless devices in the subset of slots (e.g., slots 320-b through 320-e) based on an RSRP measurement in each slot in the subset of slots. For example, the first wireless device may detect sidelink transmission from a second wireless device in resource 335-a based on performing an RSRP measurement on slot 320-b in the subset of slots (e.g., slots 320-b through 320-e). In some cases, the first wireless device may detect sidelink transmissions from other wireless devices for each slot in the subset of slots by either decoding control messages or SCI, performing an RSRP measurement, or a combination thereof. If in each of the subset of slots, the first wireless device detects sidelink transmission(s), the first wireless device determines that sidelink transmissions from V2X UEs are continuous, the first wireless device determines that V2X UEs including the first wireless device still retain the COT and can transmit in the reserved time frequency resource 330. Otherwise, the first wireless device may assume that the reserved time frequency resource 330 is no longer accessible (the UE may either give up its transmission or perform CAT2 LBT before transmitting in the reserved time frequency resource 330).

In some cases, the subset of slots may include the preceding slot of a reserved resource. For example, the subset of slots may include slot 320-e when the first wireless device reserves time frequency resource 330. The first wireless device may monitor slot 320-e. The first wireless device may then determine whether the reserved time frequency resource 330 may be accessible based on the monitoring of sidelink transmissions from the other wireless devices in slot 320-e. In some examples, the first wireless device may detect sidelink transmission from one or more other wireless devices in slot 320-e based on decoding a control message or SCI of sidelink transmission transmitted by one or more other wireless devices. For instance, the first wireless device may detect sidelink transmission from a second wireless device based on decoding a control message or SCI of sidelink transmission transmitted by the second wireless device in slot 320-e. In some examples, the first wireless device may detect sidelink transmission from one or more other wireless devices in slot 320-e based on an RSRP measurement in slot 320-e. For instance, the first wireless device may detect sidelink transmission from a second wireless device in slot 320-e over resource 335-d based on an RSRP measurement in slot 320-e. In some cases, the first wireless device may detect sidelink transmissions from other wireless devices for slot 320-e by either decoding control messages or SCI, performing an RSRP measurement, or a combination thereof.

In some cases, the first wireless device may monitor the subset of slots (e.g., slots 320-b through 320-e or slot 320-e) before reserved time frequency resources 330 for sidelink transmissions from other wireless devices in the channel 305 to identify accessibility of reserved time frequency resource 330. In some examples, if the first wireless device monitors continuous sidelink transmission or discontinuous sidelink transmission with each gap of transmission less than a threshold (e.g., 16 μs or 25 μs) in the subset of slots, the first wireless device may transmit a sidelink transmission in reserved time frequency resource 330. The first wireless device monitoring continuous sidelink transmission or discontinuous sidelink transmission with each gap of transmission less than a threshold (e.g., 16 μs or 25 μs) in the subset of slots may indicate that the first wireless device and other wireless devices retain the COT. In some examples, if the first wireless device monitors discontinuous sidelink transmission with any gap of transmission greater than a threshold (e.g., 16 μs or 25 μs) in the subset of slots, the first wireless device may assume reserved time frequency resources 330 may be no longer accessible. In some examples, the first wireless device may give up transmission in reserved time frequency resources 330 and may perform channel sensing (e.g., Type 1 channel access procedure as specified in 3GPP; or sidelink decoding based channel access as described previously) to access the channel 305 if the first wireless device still has a packet to transmit. In other examples, the first wireless device may perform channel sensing (e.g., Type 2 channel access procedure as specified in 3GPP in a sensing window) prior to utilizing the reserved time frequency resource 330. The first wireless device may then utilize the time frequency resource 330 based on the channel availability after performing the channel sensing (e.g., Type 2 channel access).

In some cases, the first wireless device may utilize time frequency resource 330 while refraining from performing channel sensing (e.g., LBT) prior to the time frequency resource 330 if the first wireless device monitors continuous sidelink transmission (e.g., no stop in transmission) or discontinuous sidelink transmission with each gap value less than a threshold (e.g., 16 μs or 25 μs) over the subset of slots. For instance, the first wireless device may monitor a subset of slots (e.g., slots 320-b through 320-e or slot 320-e) for sidelink transmission from other wireless devices. If the first wireless device monitors for sidelink transmission from one or more other wireless devices with no gaps or gap values less than a threshold (e.g., 16 μs or 25 μs) across the subset of slots in sidelink transmission over the channel 305, then the first wireless device may utilize the reserved time frequency resource 330 without performing channel sensing (e.g., LBT) prior to the time frequency resource 330. In some cases, the first wireless device may perform channel sensing (e.g., LBT without random back-off) between reserving slot 320-a and reserved slot 320-f. The first wireless device may then transmit in reserved time frequency resource 330 if the channel sensing procedure indicates channel 305 is available. For example, the first wireless device may perform energy detection in a sensing window preceding reserved time frequency resource 330. The first wireless device may then transmit a sidelink transmission in reserved time frequency resource 330 if the measured energy level in the sensing window is below an energy threshold in a sensing duration.

In some examples, the first wireless device may perform channel sensing (e.g., LBT) prior to the reserved time frequency resource 330 if the first wireless device monitors discontinuous sidelink transmission with at least one gap value greater than a threshold (e.g., 16 μs or 25 μs) in the subset of slots. For instance, the first wireless device may monitor a subset of slots (e.g., slots 320-b through 320-e or slot 320-e) for sidelink transmission from other wireless devices In some cases, a sidelink transmission from a second wireless device in resource 335-d may stop transmitting for at least a time threshold (e.g., 16 μs or 25 μs) within the slot 320-e. The first wireless device may then perform channel sensing (e.g., LBT) prior to the reserved time frequency resource 330. The first wireless device may utilize reserved time frequency resource 330 if the first wireless device confirms the channel 305 is free for transmission in the time frequency resource 330 after performing channel sensing (e.g., LBT).

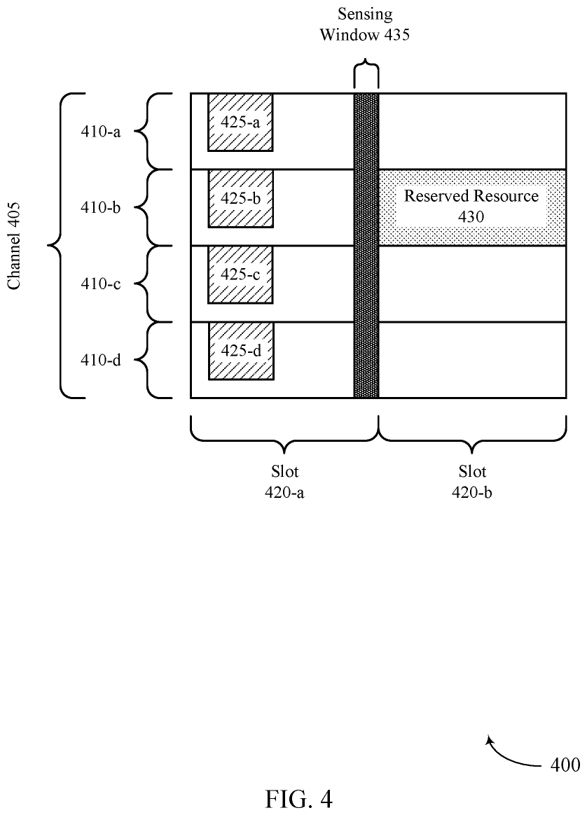

FIG. 4 illustrates an example of a time frequency diagram 400 that supports channel access with reservation for sidelink communication in unlicensed spectrum in accordance with aspects of the present disclosure. In some examples, time frequency diagram 400 may implement aspects of wireless communications systems 100 or 200. In some examples, the time frequency diagram 400 may correspond to a COT and may be a function of a frequency domain as well as a time domain. For example, time frequency diagram 400 may span over slots 420-a and 420-b in a time domain of the COT, and may span a number of subchannels (e.g., subchannels 410-a through 410-d) of a channel 405 in the frequency domain. In some examples, resources of the time frequency diagram 400 may span one symbol by one subcarrier, or one symbol by multiple subcarriers. In some examples, time frequency diagram 400 may describe the channel sensing (e.g., LBT) procedure of the present disclosure.

A first wireless device may transmit a message in a reserving resource, the message indicating a non-consecutive reserved time frequency resource 430 in slot 420-b. In some cases, the first wireless device may perform channel sensing (e.g., LBT) over a channel 405 (e.g., a sidelink channel) in a shared COT if the first wireless device monitors discontinuous sidelink transmission with at least one gap value greater than a threshold (e.g., 16 μs or 25 μs) in a subset of slots prior to the reserved time frequency resource 430. In some cases, the first wireless device may detect sidelink transmission from other wireless devices for the subset of slots by either decoding control messages or SCI, performing an RSRP measurement, or a combination thereof. In some cases, the channel sensing (e.g., LBT) may be performed in a sensing window 435. In some examples, the channel sensing (e.g., LBT) may be performed over the subchannel 410-b for the reserved time frequency resource 430. In other examples, the channel sensing (e.g., LBT) may be performed over the channel 405.

In some cases, the subset of slots may be each slot subsequent to the reserving resource and prior to the reserved time frequency resource 430 (e.g., slot 420-a). If the first wireless device detects discontinuous sidelink transmission with at least one gap value greater than a threshold (e.g., 16 μs or 25 μs) in the subset of slots, the first wireless device may perform channel sensing (e.g., LBT) in the sensing window 435. In other cases, the subset of slots may be the preceding slot 420-a of the reserved time frequency resource 430. Similarly, if the first wireless device detects discontinuous sidelink transmission with at least one gap value greater than a threshold (e.g., 16 μs or 25 μs) in slot 420-a, the first wireless device may perform channel sensing (e.g., LBT) in the sensing window 435. For instance, the first wireless device may not detect any sidelink control messages 425 from other wireless devices within slot 420-a which may indicate a gap value greater than a threshold (e.g., 16 μs or 25 μs) and may activate the first wireless device to perform channel sensing (e.g., LBT) in the sensing window 435. In some cases, the first wireless device may determine to perform channel sensing (e.g., LBT) before ending slot 420-a due to few OFDM symbols for the sidelink control messages 425.

In some cases, channel sensing may include LBT procedures. An LBT procedure may include different Categories for attempting to access an unlicensed frequency band. In some examples, channel sensing may implement a Category 2 LBT. The Category 2 LBT may include an LBT without a random back-off, and a sensing duration for the sensing window 435 which may be determined by an energy detection window size, a reception mode to transmission mode transition time, a fixed gap value, or a combination thereof. The sensing duration may begin within slot 420-a and end when slot 420-b begins. In other examples, channel sensing may implement a Category 4 LBT. The Category 4 LBT may include an LBT with a random back-off and may start sensing when the first wireless device determines discontinuous sidelink transmission with at least one gap value greater than a threshold (e.g., 16 μs or 25 μs) in a slot (e.g., slot 420-a) in the subset of slots.

In some examples, the first wireless device may detect discontinuous sidelink transmission with at least one gap value greater than a threshold (e.g., 16 μs or 25 μs) in slot 420-b prior to the reserved time frequency resource 430. In some aspects, the sensing window 435 may begin at the start of slot 420-b and end at the start of reserved time frequency resource 430.

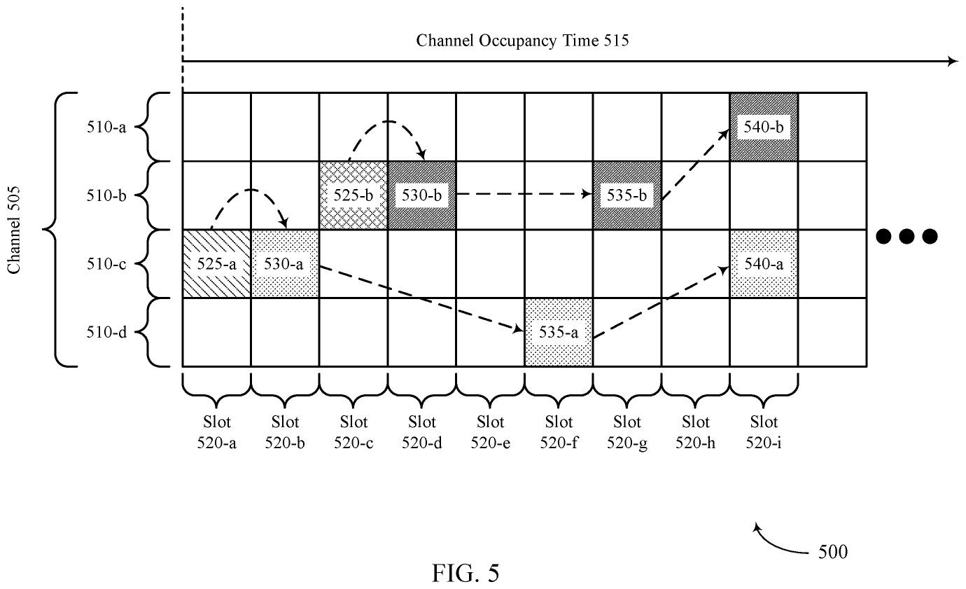

FIG. 5 illustrates an example of a time frequency diagram 500 that supports channel access with reservation for sidelink communication in unlicensed spectrum in accordance with aspects of the present disclosure. In some examples, time frequency diagram 500 may implement aspects of wireless communications systems 100 and 200. In some examples, the time frequency diagram 500 may correspond to a shared COT and may be a function of a frequency domain as well as a time domain. For example, time frequency diagram 500 may span over slots 520-a and 520-i in a time domain of the COT, and may span a number of subchannels (e.g., subchannels 510-a through 510-d) of a channel 505 in the frequency domain. In some examples, resources of the time frequency diagram 500 may span one symbol by one subcarrier, or one symbol by multiple subcarriers. In some examples, time frequency diagram 500 may describe multiple or consecutive channel access reservations with feedback transmission for sidelink communication in unlicensed spectrum.

Time frequency diagram 500 may include a first wireless device and a second wireless device sharing COT 515. In some examples, the first wireless device may reserve time frequency resource 530-a in slot 520-b consecutive to a time frequency resource 525-a. In some cases, the first wireless device may refrain from performing channel sensing (e.g., LBT) for consecutive slot reservation. Additionally or alternatively, the first wireless device may reserve in consecutive time frequency resource 530-a if the sidelink transmission in time frequency resource 525-a may not request feedback (e.g., HARQ feedback). In some examples, the first wireless device may transmit a feedback request in time frequency resource 530-a for a sidelink transmission transmitted in time frequency resource 530-a.

In some examples, the first wireless device may reserve a single resource within a sidelink transmission. For instance, a sidelink transmission in time frequency resource 525-a may reserve time frequency resource 530-a for use by the first wireless device. A sidelink transmission in time frequency resource 530-a may then reserve time frequency resource 535-a for use by the first wireless device, and a sidelink transmission in time frequency resource 535-a may then reserve time frequency resource 540-a for use by the first wireless device. In other examples, the first wireless device may reserve multiple resources with a sidelink transmission. For instance, a sidelink transmission in time frequency resource 525-a may reserve time frequency resource 530-a, time frequency resource 535-a, and time frequency resource 540-a for use by the first wireless device.

In some cases, the first wireless device may transmit a feedback request along with the reservation message transmitted in the COT. The feedback request may indicate that one or more reserved resources may be for feedback of one or more sidelink messages. Further, reserved resources may be released based on the feedback received from other wireless devices sharing the COT (e.g., the second wireless device). For example, the first wireless device may reserve time frequency resource 530-a, time frequency resource 535-a and time frequency resource 540-a through a sidelink transmission transmitted in time frequency resource 525-a. The sidelink transmission may include a feedback request which may indicate that time frequency resource 530-a may receive feedback from the second wireless device regarding the transmission sent by the first wireless device in time frequency resource 525-a. If the first wireless device receives a negative acknowledgment (NACK) feedback in time frequency resource 530-a, the first wireless device may utilize the reserved time frequency resource 535-a. If the wireless device receives an acknowledgment (ACK) feedback, then the first wireless device may release time frequency resource 535-a and time frequency resource 540-a.

In some cases, the second wireless device may employ similar techniques as the first wireless device for reservation of one or more resources (e.g., time frequency resource 530-b. time frequency resource 535-b, and time frequency resource 540-b) through a reserving sidelink transmission transmitted in the time frequency resource 525-b by the second wireless device. The first wireless device and the second wireless device may identify the reserved resources of the other by decoding control messages or SCI in sidelink transmissions, performing an RSRP measurement, or a combination thereof. For example, the second wireless device may decode the sidelink transmissions transmitted by the first wireless device in time frequency resource 525-a and time frequency resource 530-a to identify future resources (e.g., time frequency resource 535-a) reserved by the first wireless device.

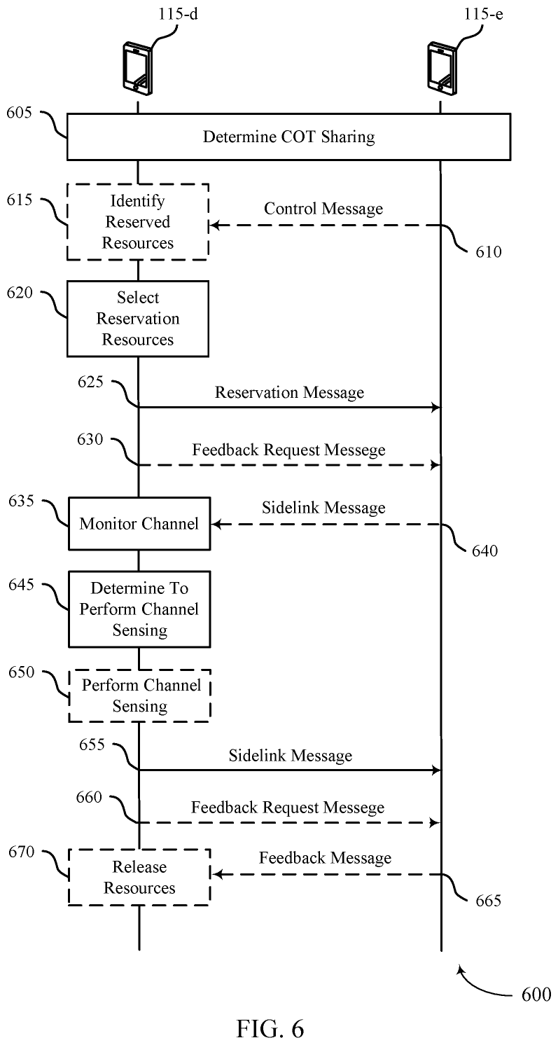

FIG. 6 illustrates an example of a process flow 600 that supports channel access with reservation for sidelink communication in unlicensed spectrum in accordance with aspects of the present disclosure. In some examples, process flow 600 may implement aspects of wireless communications system 100, 200, or 300. Process flow 600 may include sidelink transmissions between a wireless device 115-d and a wireless device 115-e, which may be examples of corresponding devices as described herein. Alternative examples of the following may be implemented, where some steps are performed in a different order than described or are not performed at all. In some cases, steps may include additional features not mentioned below, or further steps may be added.

At 605, wireless device 115-d and wireless device 115-e may each determine that a channel on an shared radio frequency spectrum band is available for use by the wireless device for a COT. wireless device 115-d and wireless device 115-e may share a COT sharing configuration. The COT sharing configuration may include SCI as well as sharing information for the COT. Based on the sharing information, wireless device 115-d and wireless device 115-e may determine to share the COT.

At 610, wireless device 115-e may transmit one or more sidelink control messages indicating a set of reserved slots reserved by wireless device 115-e for subsequent communications within the COT. wireless device 115-d may detect the one or more sidelink control messages transmitted by wireless device 115-e prior to a first slot. At 615, wireless device 115-d may decode the sidelink control message and may identify the resources reserved by wireless device 115-e as reserved (e.g., busy). In some cases, wireless device 115-d may identify the resources indicated by wireless device 115-e by performing an RSRP measurement on a control message or sidelink transmission from wireless device 115-e. wireless device 115-d may project the RSRP measurement onto the reserved resources indicated by wireless device 115-e, and may compare the RSRP measurement to an RSRP metric (e.g., threshold value) to identify the resources as reserved (e.g., busy).

At 620, wireless device 115-d may select a reserved slot within the COT for a subsequent communication by wireless device 115-d. In some examples, wireless device 115-d may select the reserved slot based on the set of identified reserved slots of wireless device 115-d or wireless device 115-e. In some cases, wireless device 115-d may select the reserved slot to be consecutive to the first slot. In some examples, wireless device 115-d may select the reserved slot to be consecutive to the first slot based on sidelink transmissions in the first slot by wireless device 115-d being independent of feedback. At 625, wireless device 115-d may transmit a message (e.g., reservation message) in the first slot of the COT over the channel. The message may indicate the reserved slot within the COT for subsequent communication by wireless device 115-d.

At 630, wireless device 115-d may transmit a feedback request for transmissions in the first slot. In some examples, the feedback request may indicate that the reserved slot may be for feedback for the transmissions. In other examples, the feedback request may indicate that the reserved slot and one or more other slots within the COT may be for feedback for the transmissions.

At 635, wireless device 115-d may monitor a subset of slots between the first slot and the reserved slot for sidelink transmissions from wireless device 115-e. In some cases, the subset of slots may be the preceding slot of the reserved resource. The monitoring of the subset of slots may include decoding control messages or SCI in each slot. For instance, if wireless device 115-d decodes control messages or SCI in a slot of the subset of slots, then wireless device 115-d may acknowledge the sidelink transmission. In some cases, the monitoring of the subset of slots may include an RSRP measurement of sidelink transmissions of each slot. For instance, wireless device 115-d may perform an RSRP measurement over a slot in the subset of slots. If the RSRP measurement exceeds a threshold, wireless device 115-d may acknowledge the sidelink transmission. At 640, wireless device 115-e may transmit sidelink messages in the subset of slots.

At 645, the wireless device 115-d may determine whether to refrain from or perform channel sensing (e.g., LBT). If wireless device 115-d monitored continuous sidelink transmission or discontinuous sidelink transmission with each gap value less than a threshold (e.g., 16 μs or 25 μs) over the subset of slots, wireless device 115-d may transmit a sidelink transmission in the reserved resource while refraining from performing channel sensing (e.g., (LBT)). In some examples, if wireless device 115-d monitored discontinuous sidelink transmission with any gap value greater than a threshold (e.g., 16 μs) or 25 μs, wireless device 115-d may perform channel sensing (e.g., LBT). In some cases, wireless device 115-d may refrain from channel sensing (e.g., (LBT)) if the reserved slot may be consecutive to the first slot.

At 650, wireless device 115-d may perform channel sensing (e.g., LBT) based on the monitoring. In some cases, channel sensing may include a Category 2 LBT procedure or a Category 4 LBT procedure. In some cases, the LBT procedure may listen over one or more symbols in the preceding slot of the reserved slot. At 655, wireless device 115-d may utilize the reserved resource by transmitting a sidelink message in the resource. In some examples, wireless device 115-d may confirm the channel is free for transmission in the resource after performing channel sensing (e.g., LBT) before utilizing the reserved resource.

At 660, wireless device 115-d may transmit a feedback request for transmissions in the reserved slot. In some cases, the feedback request may be independent of feedback for transmissions in the first slot. In some cases, the feedback request may specify one or more slots within the COT reserved for feedback. At 665, wireless device 115-d may receive feedback for transmissions in the first slot from wireless device 115-e. At 670, wireless device 115-d may release one or more other slots based on receiving feedback for the transmissions in the first slot.

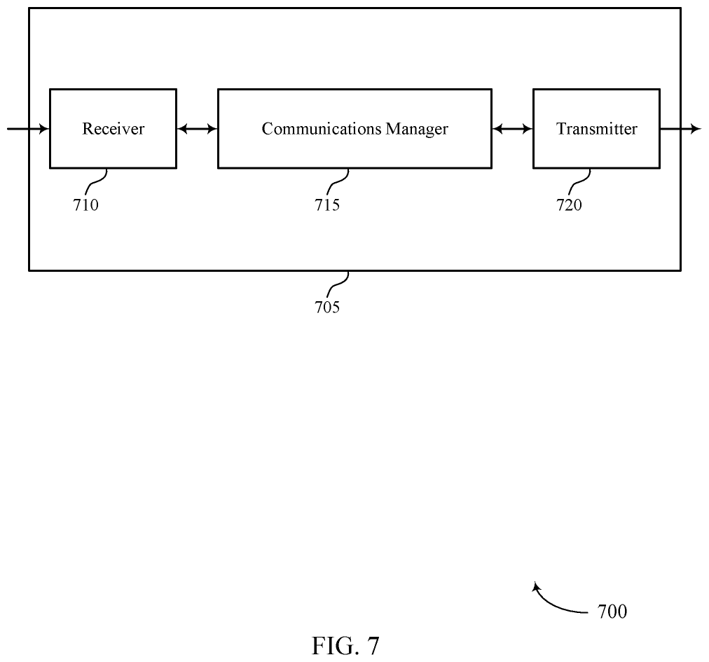

FIG. 7 shows a block diagram 700 of a device 705 that supports channel access with reservation for sidelink communication in unlicensed spectrum in accordance with aspects of the present disclosure. The device 705 may be an example of aspects of a UE 115 or a wireless device 115 as described herein. The device 705 may include a receiver 710, a communications manager 715, and a transmitter 720. The device 705 may also include a processor. Each of these components may be in communication with one another (e.g., via one or more buses).

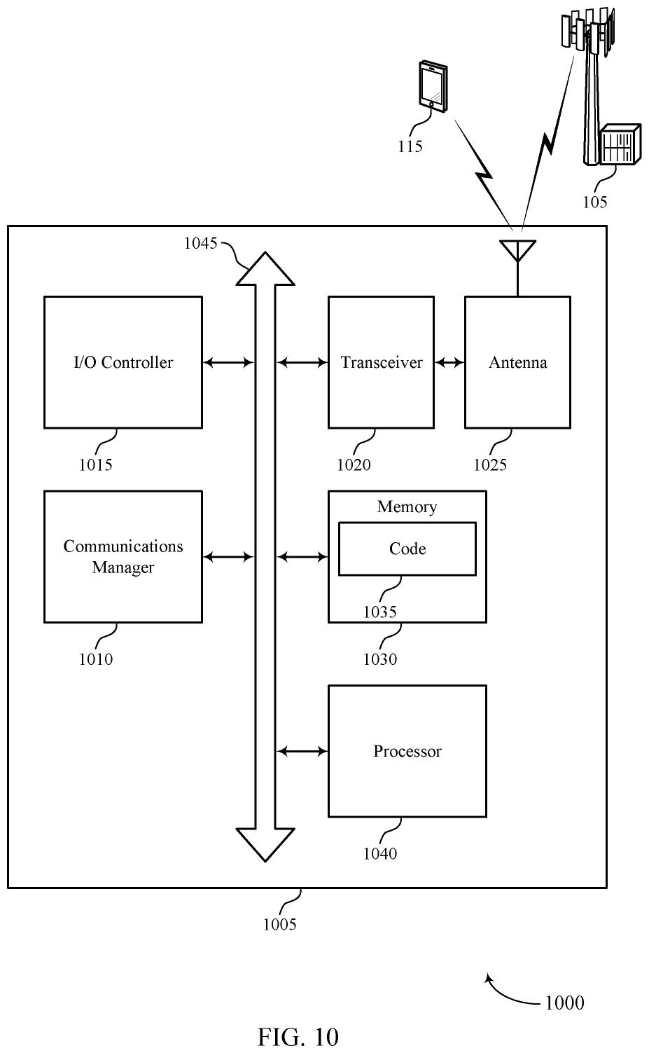

The receiver 710 may receive information such as packets, user data, or control information associated with various information channels (e.g., control channels, data channels, and information related to channel access with reservation for sidelink communication in unlicensed spectrum, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may determine that a CO in a shared radio frequency spectrum band is available for use by the UE for sidelink transmission, transmit a message in a first slot of the CO using a channel of the shared radio frequency spectrum band, the message indicating a reserved slot within the CO for a subsequent communication by the UE, and communicate in the reserved slot based on one or more control messages between the first slot and the reserved slot, one or more RSRP measurements between the first slot and the reserved slot, a channel sensing procedure with energy detection within a sensing window, or a combination thereof. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

In some examples, the communications manager 715 may be implemented as an integrated circuit or chipset for a mobile device modem, and the receiver 710 and transmitter 720 may be implemented as analog components (e.g., amplifiers, filters, antennas) coupled with the mobile device modem to enable wireless transmission and reception over one or more bands.

The communications manager 715 as described herein may be implemented to realize one or more potential advantages. One implementation may enable the device 705 to provide assistance for efficient channel access for sidelink communications between the device 705 and one or more other devices in unlicensed spectrum. Based on the techniques for efficient channel access for sidelink communications between the device 705 and one or more other devices in unlicensed spectrum, the device 705 may support channel reservation and, therefore, may refrain from additional channel sensing procedures to utilize time frequency resources in the channel. As such, the device 705 may increase the likelihood of efficient occupancy of the channel and, accordingly, may more efficiently power a processor or one or more processing units associated with transmitting and receiving communications over the channel, which may enable the device to save power and increase battery life.

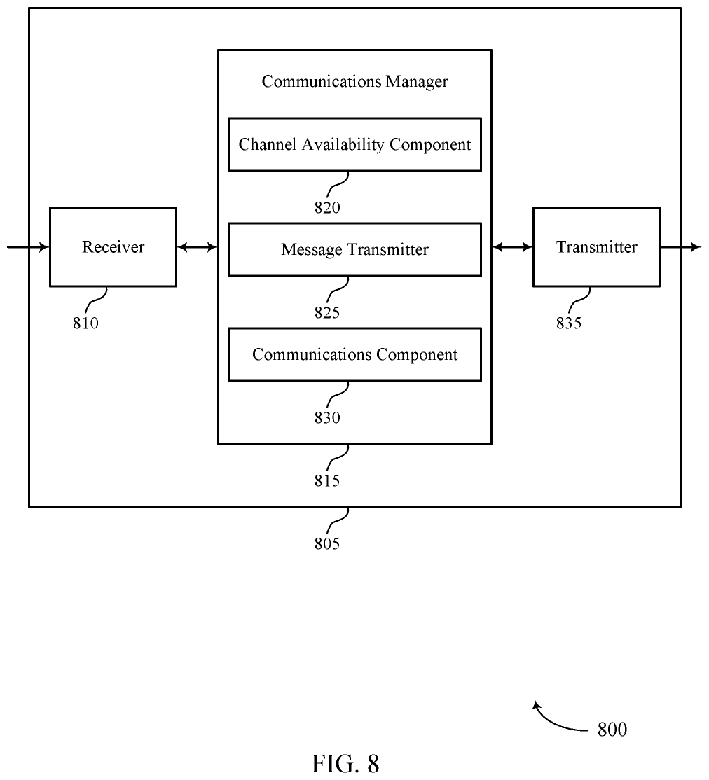

FIG. 8 shows a block diagram 800 of a device 805 that supports channel access with reservation for sidelink communication in unlicensed spectrum in accordance with aspects of the present disclosure. The device 805 may be an example of aspects of a device 705, a UE 115, or a wireless device 115 as described herein. The device 805 may include a receiver 810, a communications manager 815, and a transmitter 835. The device 805 may also include a processor. Each of these components may be in communication with one another (e.g., via one or more buses).

The receiver 810 may receive information such as packets, user data, or control information associated with various information channels (e.g., control channels, data channels, and information related to channel access with reservation for sidelink communication in unlicensed spectrum, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a channel availability component 820, a message transmitter 825, and a communications component 830. The communications manager 815 may be an example of aspects of the communications manager 1010 described herein.

The channel availability component 820 may determine that a CO in a shared radio frequency spectrum band is available for use by the UE for sidelink transmission.

The message transmitter 825 may transmit a message in a first slot of the CO using a channel of the shared radio frequency spectrum band, the message indicating a reserved slot within the CO for a subsequent communication by the UE.

The communications component 830 may communicate in the reserved slot based on one or more control messages between the first slot and the reserved slot, one or more RSRP measurements between the first slot and the reserved slot, a channel sensing procedure with energy detection within a sensing window, or a combination thereof.

The transmitter 835 may transmit signals generated by other components of the device 805. In some examples, the transmitter 835 may be collocated with a receiver 810 in a transceiver module. For example, the transmitter 835 may be an example of aspects of the transceiver 1020 described with reference to FIG. 10. The transmitter 835 may utilize a single antenna or a set of antennas.

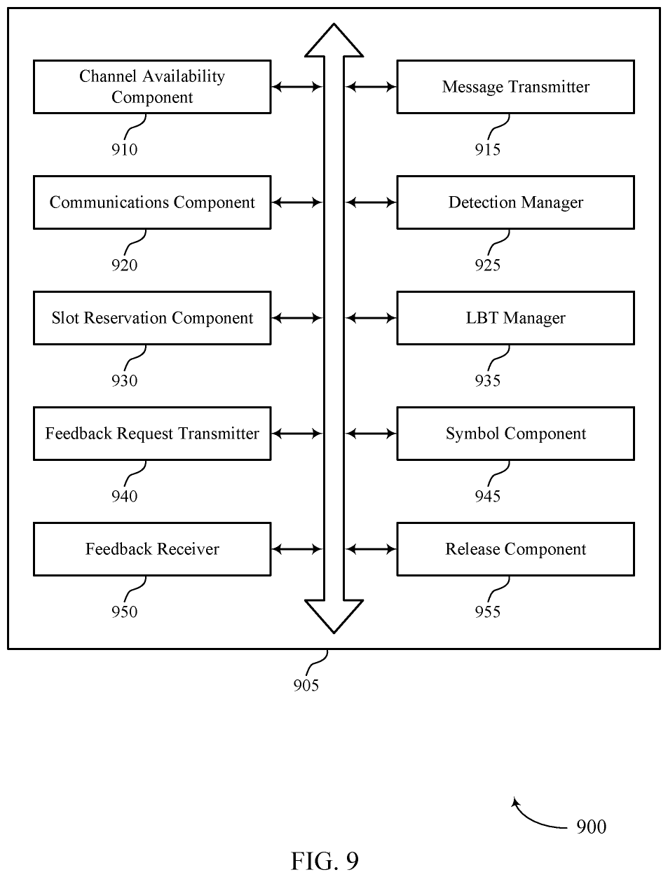

FIG. 9 shows a block diagram 900 of a communications manager 905 that supports channel access with reservation for sidelink communication in unlicensed spectrum in accordance with aspects of the present disclosure. The communications manager 905 may be an example of aspects of a communications manager 715, a communications manager 815, or a communications manager 1010 described herein. The communications manager 905 may include a channel availability component 910, a message transmitter 915, a communications component 920, a detection manager 925, a slot reservation component 930, a LBT manager 935, a feedback request transmitter 940, a symbol component 945, a feedback receiver 950, and a release component 955. Each of these modules may communicate, directly or indirectly, with one another (e.g., via one or more buses).

The channel availability component 910 may determine that a CO in a shared radio frequency spectrum band is available for use by the UE for sidelink transmission.

The message transmitter 915 may transmit a message in a first slot of the CO using a channel of the shared radio frequency spectrum band, the message indicating a reserved slot within the CO for a subsequent communication by the UE.

The communications component 920 may communicate in the reserved slot based on one or more control messages between the first slot and the reserved slot, one or more RSRP measurements between the first slot and the reserved slot, a channel sensing procedure with energy detection within a sensing window, or a combination thereof.

In some examples, the communications component 920 may communicate in the reserved slot based on detecting one or more sidelink control messages from at least one other UE in a second slot preceding the reserved slot, where the second slot and the reserved slot are consecutive.

In some examples, the communications component 920 may communicate in the reserved slot based on detecting one or more sidelink control messages from at least one other UE in each slot between the first slot and the reserved slot.

In some examples, the communications component 920 may communicate in the reserved slot based on the RSRP measurement of sidelink transmissions of all slots between the first slot and the reserved slot exceeding the RSRP threshold.

In some examples, the communications component 920 may communicate in the reserved slot based on the RSRP measurement of sidelink transmissions in a second slot consecutive to the reserved slot exceeding the RSRP threshold.

In some examples, the communications component 920 may communicate in the reserved slot based on the energy detection in a sensing window preceding the reserved slot being below the energy detection threshold.

The detection manager 925 may detect one or more sidelink control messages from at least one other UE indicating a set of reserved slots reserved by the at least one other UE for subsequent communications within the CO.

In some examples, the detection manager 925 may detect one or more sidelink control messages from at least one other UE in a second slot preceding the reserved slot, where the second slot and the reserved slot are consecutive.

In some examples, the detection manager 925 may detect one or more sidelink control messages from at least one other UE in each slot between the first slot and the reserved slot.

The slot reservation component 930 may select the reserved slot based on the set of reserved slots such that each slot between the first slot and the reserved slot is reserved by the UE or the at least one other UE.

In some examples, the slot reservation component 930 may select the reserved slot to be consecutive to the first slot.

In some examples, the slot reservation component 930 may select the reserved slot to be consecutive to the first slot based on transmissions in the first slot by the UE being independent of feedback in response to the transmissions.

The LBT manager 935 may refrain from performing the channel sensing procedure before the reserved slot based on the reserved slot and the first slot being consecutive.

In some examples, the LBT manager 935 may perform the channel sensing procedure in one or more symbols of a second slot preceding the reserved slot, where the second slot and the reserved slot are consecutive.

The feedback request transmitter 940 may transmit a feedback request for transmissions in the reserved slot independent of feedback for transmissions in the first slot.

In some examples, the feedback request transmitter 940 may transmit a feedback request for transmissions in the first slot, the feedback request indicating that the reserved slot is for feedback for the transmissions.

In some examples, the feedback request transmitter 940 may transmit a feedback request for transmissions in the first slot, the feedback request indicating that the reserved slot and one or more other slots within the COT interval are for feedback for the transmissions.

In some cases, the feedback request specifies one or more slots within the COT interval reserved for feedback.

The symbol component 945 may determine the one or more symbols based on a sensing window size, a reception mode to transmission mode transition time, a fixed gap value, or a combination thereof.

The feedback receiver 950 may receive, in the reserved slot, feedback for the transmissions in the first slot.

The release component 955 may release the one or more other slots based on receiving feedback for the transmissions in the first slot.

FIG. 10 shows a diagram of a system 1000 including a device 1005 that supports channel access with reservation for sidelink communication in unlicensed spectrum in accordance with aspects of the present disclosure. The device 1005 may be an example of or include the components of device 705, device 805, a UE 115, or a wireless device 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may determine that a CO in a shared radio frequency spectrum band is available for use by the UE for sidelink transmission, transmit a message in a first slot of the CO using a channel of the shared radio frequency spectrum band, the message indicating a reserved slot within the CO for a subsequent communication by the UE, and communicate in the reserved slot based on one or more control messages between the first slot and the reserved slot, one or more RSRP measurements between the first slot and the reserved slot, a channel sensing procedure with energy detection within a sensing window, or a combination thereof.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic input/output system (BIOS) which may control basic hardware or software operation such as the interaction with peripheral components or devices.

The processor 1040 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting channel access with reservation for sidelink communication in unlicensed spectrum).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

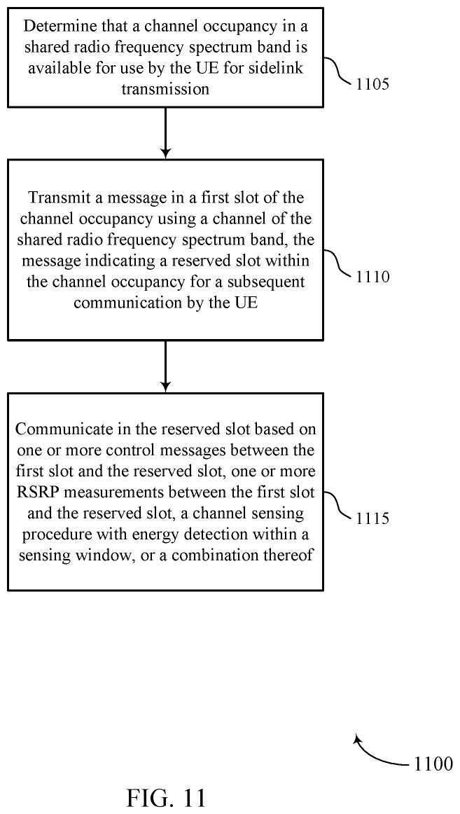

FIG. 11 shows a flowchart illustrating a method 1100 that supports channel access with reservation for sidelink communication in unlicensed spectrum in accordance with aspects of the present disclosure. The operations of method 1100 may be implemented by a UE 115 or its components or a wireless device 115 or its components as described herein. For example, the operations of method 1100 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1105, the UE may determine that a CO in a shared radio frequency spectrum band is available for use by the UE for sidelink transmission. The operations of 1105 may be performed according to the methods described herein. In some examples, aspects of the operations of 1105 may be performed by a channel availability component as described with reference to FIGS. 7 through 10.

At 1110, the UE may transmit a message in a first slot of the CO using a channel of the shared radio frequency spectrum band, the message indicating a reserved slot within the CO for a subsequent communication by the UE. The operations of 1110 may be performed according to the methods described herein. In some examples, aspects of the operations of 1110 may be performed by a message transmitter as described with reference to FIGS. 7 through 10.

At 1115, the UE may communicate in the reserved slot based on one or more control messages between the first slot and the reserved slot, one or more RSRP measurements between the first slot and the reserved slot, a channel sensing procedure with energy detection within a sensing window, or a combination thereof. The operations of 1115 may be performed according to the methods described herein. In some examples, aspects of the operations of 1115 may be performed by a communications component as described with reference to FIGS. 7 through 10.

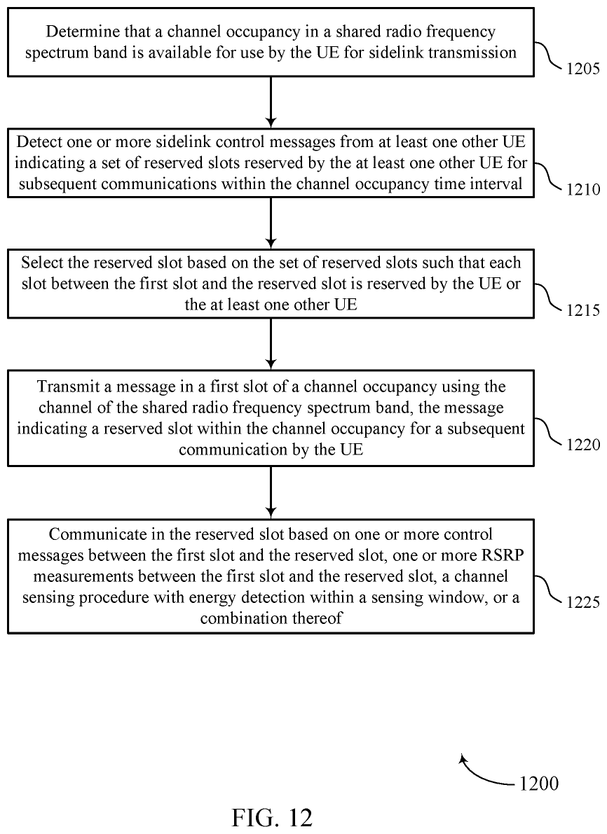

FIG. 12 shows a flowchart illustrating a method 1200 that supports channel access with reservation for sidelink communication in unlicensed spectrum in accordance with aspects of the present disclosure. The operations of method 1200 may be implemented by a UE 115 or its components or a wireless device 115 or its components as described herein. For example, the operations of method 1200 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1205, the UE may determine that a CO in a shared radio frequency spectrum band is available for use by the UE for sidelink transmission. The operations of 1205 may be performed according to the methods described herein. In some examples, aspects of the operations of 1205 may be performed by a channel availability component as described with reference to FIGS. 7 through 10.

At 1210, the UE may detect one or more sidelink control messages from at least one other UE indicating a set of reserved slots reserved by the other UEs for subsequent communications within the COT interval. The operations of 1210 may be performed according to the methods described herein. In some examples, aspects of the operations of 1210 may be performed by a detection manager as described with reference to FIGS. 7 through 10.

At 1215, the UE may select the reserved slot based on the set of reserved slots such that each slot between the first slot and the reserved slot is reserved by the UE or the at least one other UE. The operations of 1215 may be performed according to the methods described herein. In some examples, aspects of the operations of 1215 may be performed by a slot reservation component as described with reference to FIGS. 7 through 10.

At 1220, the UE may transmit a message in a first slot of the CO using a channel of the shared radio frequency spectrum band, the message indicating a reserved slot within the CO for a subsequent communication by the UE. The operations of 1220 may be performed according to the methods described herein. In some examples, aspects of the operations of 1220 may be performed by a message transmitter as described with reference to FIGS. 7 through 10.

At 1225, the UE may communicate in the reserved slot based on one or more control messages between the first slot and the reserved slot, one or more RSRP measurements between the first slot and the reserved slot, a channel sensing procedure with energy detection within a sensing window, or a combination thereof. The operations of 1225 may be performed according to the methods described herein. In some examples, aspects of the operations of 1225 may be performed by a communications component as described with reference to FIGS. 7 through 10.

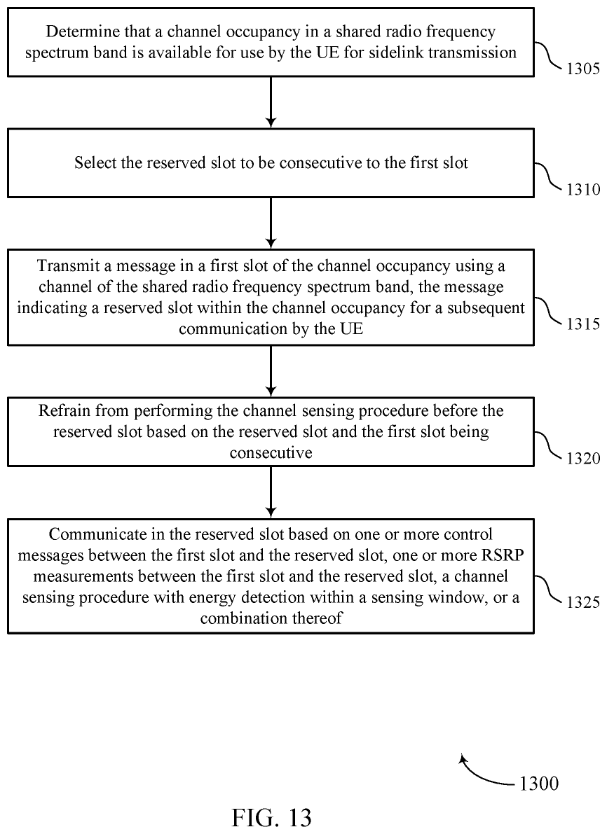

FIG. 13 shows a flowchart illustrating a method 1300 that supports channel access with reservation for sidelink communication in unlicensed spectrum in accordance with aspects of the present disclosure. The operations of method 1300 may be implemented by a UE 115 or its components or a wireless device 115 or its components as described herein. For example, the operations of method 1300 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1305, the UE may determine that a CO in a shared radio frequency spectrum band is available for use by the UE for sidelink transmission. The operations of 1305 may be performed according to the methods described herein. In some examples, aspects of the operations of 1305 may be performed by a channel availability component as described with reference to FIGS. 7 through 10.

At 1310, the UE may select the reserved slot to be consecutive to the first slot. The operations of 1310 may be performed according to the methods described herein. In some examples, aspects of the operations of 1310 may be performed by a slot reservation component as described with reference to FIGS. 7 through 10.

At 1315, the UE may transmit a message in a first slot of the CO using a channel of the shared radio frequency spectrum band, the message indicating a reserved slot within the CO for a subsequent communication by the UE. The operations of 1315 may be performed according to the methods described herein. In some examples, aspects of the operations of 1315 may be performed by a message transmitter as described with reference to FIGS. 7 through 10.

At 1320, the UE may refrain from performing the channel sensing procedure before the reserved slot based on the reserved slot and the first slot being consecutive. The operations of 1320 may be performed according to the methods described herein. In some examples, aspects of the operations of 1320 may be performed by a LBT manager as described with reference to FIGS. 7 through 10.

At 1325, the UE may communicate in the reserved slot based on one or more control messages between the first slot and the reserved slot, one or more RSRP measurements between the first slot and the reserved slot, a channel sensing procedure with energy detection within a sensing window, or a combination thereof. The operations of 1325 may be performed according to the methods described herein. In some examples, aspects of the operations of 1325 may be performed by a communications component as described with reference to FIGS. 7 through 10.

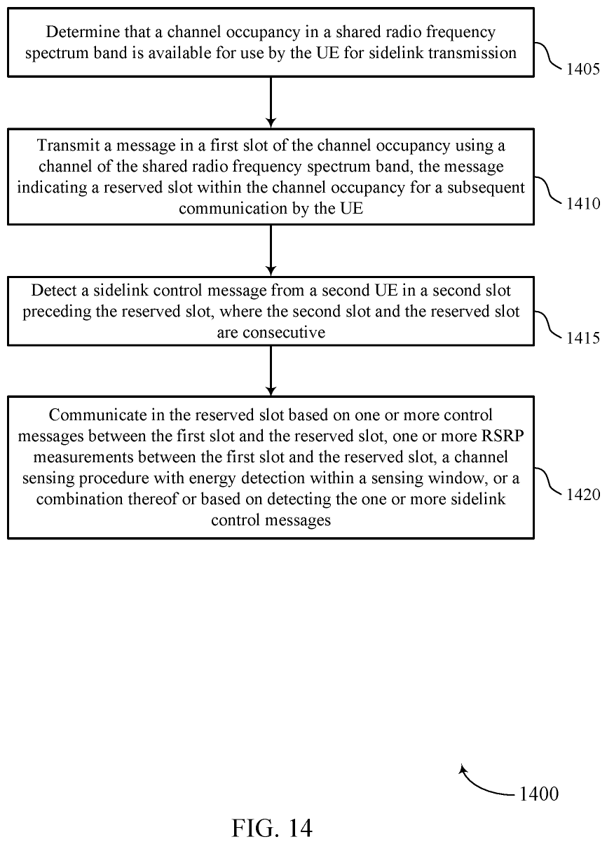

FIG. 14 shows a flowchart illustrating a method 1400 that supports channel access with reservation for sidelink communication in unlicensed spectrum in accordance with aspects of the present disclosure. The operations of method 1400 may be implemented by a UE 115 or its components or a wireless device 115 or its components as described herein. For example, the operations of method 1400 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1405, the UE may determine that a CO in a shared radio frequency spectrum band is available for use by the UE for sidelink transmission. The operations of 1405 may be performed according to the methods described herein. In some examples, aspects of the operations of 1405 may be performed by a channel availability component as described with reference to FIGS. 7 through 10.

At 1410, the UE may transmit a message in a first slot of the CO using a channel of the shared radio frequency spectrum band, the message indicating a reserved slot within the CO for a subsequent communication by the UE. The operations of 1410 may be performed according to the methods described herein. In some examples, aspects of the operations of 1410 may be performed by a message transmitter as described with reference to FIGS. 7 through 10.

At 1415, the UE may detect one or more sidelink control messages from at least one other UE in a second slot preceding the reserved slot, where the second slot and the reserved slot are consecutive. The operations of 1415 may be performed according to the methods described herein. In some examples, aspects of the operations of 1415 may be performed by a detection manager as described with reference to FIGS. 7 through 10.

At 1420, the UE communicate in the reserved slot based one or more control messages between the first slot and the reserved slot, one or more RSRP measurements between the first slot and the reserved slot, a channel sensing procedure with energy detection within a sensing window, or a combination thereof or based on detecting the one or more sidelink control messages in the second slot preceding the reserved slot. The operations of 1420 may be performed according to the methods described herein. In some examples, aspects of the operations of 1420 may be performed by a communications component as described with reference to FIGS. 7 through 10.

The following provides an overview of aspects of the present disclosure:

Aspect 1: A method for wireless communications at a UE, including: determining that a CO in a shared radio frequency spectrum band is available for use by the UE for sidelink transmission; transmitting a message in a first slot of the CO using a channel of the shared radio frequency spectrum band, the message indicating a reserved slot within the CO for a subsequent communication by the UE; and communicating in the reserved slot based at least in part on one or more control messages between the first slot and the reserved slot, one or more RSRP measurements between the first slot and the reserved slot, a channel sensing procedure with energy detection within a sensing window, or a combination thereof.

Aspect 2: The method of aspect 1, further including: detecting one or more sidelink control messages from at least one other UE indicating a set of reserved slots reserved by the at least one other UE for subsequent communications within the CO; and selecting the reserved slot based at least in part on the set of reserved slots such that each slot between the first slot and the reserved slot is reserved by the UE or the at least one other UE.

Aspect 3: The method of any of aspects 1 through 2, further including: selecting the reserved slot to be consecutive to the first slot; and refraining from performing the channel sensing procedure before the reserved slot based at least in part on the reserved slot and the first slot being consecutive.

Aspect 4: The method of aspect 3, further including: selecting the reserved slot to be consecutive to the first slot based at least in part on transmissions in the first slot by the UE being independent of feedback in response to the transmissions.

Aspect 5: The method of any of aspects 3 through 4, where communicating the reserved slot includes: transmitting a feedback request for transmissions in the reserved slot.

Aspect 6: The method of aspect 5, where the feedback request specifies one or more slots within the CO reserved for feedback.

Aspect 7: The method of any of aspects 1 through 6, further including: detecting, as part of the channel sensing procedure, one or more sidelink control messages from at least one other UE in a second slot preceding the reserved slot, where the second slot and the reserved slot are consecutive; and communicating in the reserved slot based at least in part on detecting the one or more sidelink control messages.

Aspect 8: The method of any of aspects 1 through 7, further including: detecting, as part of the channel sensing procedure, one or more sidelink control messages from at least one other UE in each slot between the first slot and the reserved slot; and communicating in the reserved slot based at least in part on detecting the one or more sidelink control messages in each slot between the first slot and the reserved slot.

Aspect 9: The method of any of aspects 1 through 8, further including: communicating in the reserved slot based at least in part on an RSRP measurement of sidelink transmissions in all slots between the first slot and the reserved slot exceeding an RSRP threshold.

Aspect 10: The method of any of aspects 1 through 9, further including: communicating in the reserved slot based at least in part on an RSRP measurement of sidelink transmissions in a second slot consecutive to the reserved slot exceeding an RSRP threshold.

Aspect 11: The method of any of aspects 1 through 10, further including: communicating in the reserved slot based at least in part on the energy detection in the sensing window between the first slot and the reserved slot being below an energy detection threshold.

Aspect 12: The method of aspect 11, further including: performing energy detection in one or more symbols of a second slot preceding the reserved slot, where the second slot and the reserved slot are consecutive.

Aspect 13: The method of aspect 12, further including: determining the one or more symbols based at least in part on a sensing window size, a reception mode to transmission mode transition time, a fixed gap value, or a combination thereof.

Aspect 14: The method of any of aspects 1 through 13, further including: transmitting a feedback request for transmissions in the first slot, the feedback request indicating that the reserved slot is for feedback for the transmissions.

Aspect 15: The method of any of aspects 1 through 14, further including: transmitting a feedback request for transmissions in the first slot, the feedback request indicating that the reserved slot and one or more other slots within the CO are for feedback for the transmissions.

Aspect 16: The method of aspect 15, further including: receiving, in the reserved slot, feedback for the transmissions in the first slot; and releasing the one or more other slots based at least in part on receiving feedback for the transmissions in the first slot.

Aspect 17: An apparatus for wireless communications at a UE, including a processor; memory coupled with the processor; and instructions stored in the memory and executable by the processor to cause the apparatus to perform a method of any of aspects 1 through 16.

Aspect 18: An apparatus for wireless communications at a UE, including at least one means for performing a method of any of aspects 1 through 16.

Aspect 19: A non-transitory computer-readable medium storing code for wireless communications at a UE, the code including instructions executable by a processor to perform a method of any of aspects 1 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
determining that a channel occupancy in a shared radio frequency spectrum band is available for use by the UE for sidelink transmission;
transmitting a message in a first slot of the channel occupancy using a channel of the shared radio frequency spectrum band, the message indicating a reserved slot within the channel occupancy for a subsequent communication by the UE; and
communicating in the reserved slot based at least in part on one or more control messages between the first slot and the reserved slot, one or more reference signal received power (RSRP) measurements between the first slot and the reserved slot, a channel sensing procedure with energy detection within a sensing window, or a combination thereof.

2. The method of claim 1, further comprising:
detecting one or more sidelink control messages from at least one other UE indicating a set of reserved slots reserved by the at least one other UE for subsequent communications within the channel occupancy; and
selecting the reserved slot based at least in part on the set of reserved slots such that each slot between the first slot and the reserved slot is reserved by the UE or the at least one other UE.

3. The method of claim 1, further comprising:
selecting the reserved slot to be consecutive to the first slot; and
refraining from performing the channel sensing procedure before the reserved slot based at least in part on the reserved slot and the first slot being consecutive.

4. The method of claim 3, further comprising:
selecting the reserved slot to be consecutive to the first slot based at least in part on transmissions in the first slot by the UE being independent of feedback in response to the transmissions.

5. The method of claim 3, wherein communicating the reserved slot comprises:
transmitting a feedback request for transmissions in the reserved slot.

6. The method of claim 5, wherein the feedback request specifies one or more slots within the channel occupancy reserved for feedback.

7. The method of claim 1, further comprising:
detecting, as part of the channel sensing procedure, one or more sidelink control messages from at least one other UE in a second slot preceding the reserved slot, wherein the second slot and the reserved slot are consecutive; and
communicating in the reserved slot based at least in part on detecting the one or more sidelink control messages.

8. The method of claim 1, further comprising:
detecting, as part of the channel sensing procedure, one or more sidelink control messages from at least one other UE in each slot between the first slot and the reserved slot; and
communicating in the reserved slot based at least in part on detecting the one or more sidelink control messages in each slot between the first slot and the reserved slot.

9. The method of claim 1, further comprising:
communicating in the reserved slot based at least in part on an RSRP measurement of sidelink transmissions in all slots between the first slot and the reserved slot exceeding an RSRP threshold.

10. The method of claim 1, further comprising:
communicating in the reserved slot based at least in part on an RSRP measurement of sidelink transmissions in a second slot consecutive to the reserved slot exceeding an RSRP threshold.

11. The method of claim 1, further comprising:
communicating in the reserved slot based at least in part on the energy detection in the sensing window between the first slot and the reserved slot being below an energy detection threshold.

12. The method of claim 11, further comprising:
performing energy detection in one or more symbols of a second slot preceding the reserved slot, wherein the second slot and the reserved slot are consecutive.

13. The method of claim 12, further comprising:
determining the one or more symbols based at least in part on a sensing window size, a reception mode to transmission mode transition time, a fixed gap value, or a combination thereof.

14. The method of claim 1, further comprising:
transmitting a feedback request for transmissions in the first slot, the feedback request indicating that the reserved slot is for feedback for the transmissions.

15. The method of claim 1, further comprising:
transmitting a feedback request for transmissions in the first slot, the feedback request indicating that the reserved slot and one or more other slots within the channel occupancy are for feedback for the transmissions.

16. The method of claim 15, further comprising:
receiving, in the reserved slot, feedback for the transmissions in the first slot; and
releasing the one or more other slots based at least in part on receiving feedback for the transmissions in the first slot.

17. An apparatus for wireless communications at a user equipment (UE), comprising:
a processor;
memory coupled with the processor; and
instructions stored in the memory and executable by the processor to cause the apparatus to:
determine that a channel occupancy in a shared radio frequency spectrum band is available for use by the UE for sidelink transmission;
transmit a message in a first slot of the channel occupancy using a channel of the shared radio frequency spectrum band, the message indicating a reserved slot within the channel occupancy for a subsequent communication by the UE; and
communicate in the reserved slot based at least in part on one or more control messages between the first slot and the reserved slot, one or more reference signal received power (RSRP) measurements between the first slot and the reserved slot, a channel sensing procedure with energy detection within a sensing window, or a combination thereof.

18. The apparatus of claim 17, wherein the instructions are further executable by the processor to cause the apparatus to:
detect one or more sidelink control messages from at least one other UE indicating a set of reserved slots reserved by the at least one other UE for subsequent communications within the channel occupancy; and
select the reserved slot based at least in part on the set of reserved slots such that each slot between the first slot and the reserved slot is reserved by the UE or the at least one other UE.

19. The apparatus of claim 17, wherein the instructions are further executable by the processor to cause the apparatus to:
select the reserved slot to be consecutive to the first slot; and
refrain from performing the channel sensing procedure before the reserved slot based at least in part on the reserved slot and the first slot being consecutive.

20. The apparatus of claim 19, wherein the instructions are further executable by the processor to cause the apparatus to:
select the reserved slot to be consecutive to the first slot based at least in part on transmissions in the first slot by the UE being independent of feedback in response to the transmissions.

21. The apparatus of claim 19, wherein the instructions to communicate the reserved slot are executable by the processor to cause the apparatus to:
transmit a feedback request for transmissions in the reserved slot.

22. The apparatus of claim 21, wherein the feedback request specifies one or more slots within the channel occupancy reserved for feedback.

23. The apparatus of claim 17, wherein the instructions are further executable by the processor to cause the apparatus to:
detect, as part of the channel sensing procedure, one or more sidelink control messages from at least one other UE in a second slot preceding the reserved slot, wherein the second slot and the reserved slot are consecutive; and
communicate in the reserved slot based at least in part on detecting the one or more sidelink control messages.

24. The apparatus of claim 17, wherein the instructions are further executable by the processor to cause the apparatus to:
detect, as part of the channel sensing procedure, one or more sidelink control messages from at least one other UE in each slot between the first slot and the reserved slot; and
communicate in the reserved slot based at least in part on detecting the one or more sidelink control messages in each slot between the first slot and the reserved slot.

25. The apparatus of claim 17, wherein the instructions are further executable by the processor to cause the apparatus to:
communicate in the reserved slot based at least in part on an RSRP measurement of sidelink transmissions in all slots between the first slot and the reserved slot exceeding an RSRP threshold.

26. The apparatus of claim 17, wherein the instructions are further executable by the processor to cause the apparatus to:
communicate in the reserved slot based at least in part on an RSRP measurement of sidelink transmissions in a second slot consecutive to the reserved slot exceeding an RSRP threshold.

27. The apparatus of claim 17, wherein the instructions are further executable by the processor to cause the apparatus to:
communicate in the reserved slot based at least in part on the energy detection in the sensing window between the first slot and the reserved slot being below an energy detection threshold.

28. The apparatus of claim 27, wherein the instructions are further executable by the processor to cause the apparatus to:
perform energy detection in one or more symbols of a second slot preceding the reserved slot, wherein the second slot and the reserved slot are consecutive.

29. An apparatus for wireless communications at a user equipment (UE), comprising:
means for determining that a channel occupancy in a shared radio frequency spectrum band is available for use by the UE for sidelink transmission;
means for transmitting a message in a first slot of the channel occupancy using a channel of the shared radio frequency spectrum band, the message indicating a reserved slot within the channel occupancy for a subsequent communication by the UE; and
means for communicating in the reserved slot based at least in part on one or more control messages between the first slot and the reserved slot, one or more reference signal received power (RSRP) measurements between the first slot and the reserved slot, a channel sensing procedure with energy detection within a sensing window, or a combination thereof.

30. A non-transitory computer-readable medium storing code for wireless communications at a user equipment (UE), the code comprising instructions executable by a processor to:
determine that a channel occupancy in a shared radio frequency spectrum band is available for use by the UE for sidelink transmission;
transmit a message in a first slot of the channel occupancy using a channel of the shared radio frequency spectrum band, the message indicating a reserved slot within the channel occupancy for a subsequent communication by the UE; and
communicate in the reserved slot based at least in part on one or more control messages between the first slot and the reserved slot, one or more reference signal received power (RSRP) measurements between the first slot and the reserved slot, a channel sensing procedure with energy detection within a sensing window, or a combination thereof.
